(19) United States
(12) Patent Application Publication
(10) Pub. No.: US 2026/0044859 A1
(43) Pub. Date: Feb. 12, 2026

(54) System, Method, and Computer Program Product for Generating Synthetic Graphs That Simulate Real-Time Transactions

(71) Applicant: Visa International Service Association, San Francisco, CA (US)

(72) Inventors: Xiao Tian, Austin, TX (US); Mahashweta Das, Campbell, CA (US); Chiranjeet Chetia, Round Rock, TX (US)

(21) Appl. No.: 19/360,208

(22) Filed: Oct. 16, 2025

Related U.S. Application Data
(63) Continuation of application No. 18/272,810.
(60) Provisional application No. 63/138,920, filed on Jan. 19, 2021.
(60) Provisional application No. 63/190,439, filed on May 19, 2021.

(51) Int. Cl. G06Q 20/40

(52) U.S. Cl. CPC G06Q 20/4016

(57) ABSTRACT

Provided is a computer-implemented method for generating synthetic graphs that simulate real-time payment transactions that includes generating a base payment graph includes a plurality of nodes and a plurality of edges connecting the plurality of nodes, wherein each node represents an entity and each edge represents a probability that a real-time-payment transaction may be conducted involving two entities that are connected by the edge, wherein the real-payment transaction is artificially created, generating a plurality of dynamic payment graphs based on the base payment graph, inserting patterns representing adversarial activity into the plurality of dynamic payment graphs, and performing an action associated with a machine learning technique using the plurality of dynamic payment graphs. Systems and computer program products are also provided.

### CROSS-REFERENCE TO RELATED APPLICATIONS

This application is a continuation application of U.S. patent application Ser. No. 18/272,810, filed Jan. 19, 2022, which is the United States national phase of International Application No. PCT/US2022/012905 filed Jan. 19, 2022, and claims priority to U.S. Provisional Patent Application No. 63/138,920, filed Jan. 19, 2021, and U.S. Provisional Patent Application No. 63/190,439, filed May 19, 2021, the disclosures of which are hereby incorporated by reference in their entireties.

### BACKGROUND

### 1. Technical Field

This disclosure relates generally to systems, devices, products, apparatus, and methods for generating synthetic graphs and, in non-limiting embodiments or aspects, to a system, product, and method for generating synthetic graphs that simulate real-time payment transactions.

### 2. Technical Considerations

A real-time payment transaction (e.g., a faster payment, an instant payment, an immediate payment, and/or the like) may refer to a payment transaction in which the transmission of a payment message and availability of funds associated with the payment transaction to a payee from a payer is carried out instantaneously, such that the transfer of funds occurs in real-time or near real-time. A real-time payment transaction system may include technology that enables instantaneous fund transfers between financial institutions and financial systems. In addition, the technology of a real-time payment transaction system may be designed to facilitate payment transactions across payment categories, including business-to-business (B2B), business-to-consumer (B2C), consumer-to-business (C2B), peer-to-peer (P2P), government-to-citizen (G2C), and/or account-to-account (A2A) transactions.

However, due to the nascent nature of real-time payment transactions, there are not currently compiled datasets that are publicly available or that correspond to historical actual (e.g., real-world) real-time payment transactions. With this, there are not available datasets from which machine learning techniques can be developed to provide risk management and decision making.

### SUMMARY

Accordingly, provided are improved systems, devices, products, apparatus, and/or methods for generating synthetic graphs that simulate real-time payment transactions.

According to some non-limiting embodiments or aspects, provided is a method for generating synthetic graphs that simulate real-time payment transactions. The method includes generating, with at least one processor, a base payment graph comprising a plurality of nodes and a plurality of edges connecting the plurality of nodes, wherein each node represents an entity and each edge represents a probability that a real-time payment transaction may be conducted involving two entities that are connected by the edge, wherein the real-time payment transaction is artificially created. The method also includes generating, with the at least one processor, a plurality of dynamic payment graphs based on the base payment graph. The method further includes inserting, with the at least one processor, patterns representing adversarial activity into the plurality of dynamic payment graphs. The method further includes performing, with the at least one processor, an action associated with a machine learning technique using the plurality of dynamic payment graphs.

According to some non-limiting embodiments or aspects, provided is a system for generating synthetic graphs that simulate real-time payment transactions. The system includes at least one processor, wherein the at least one processor is programmed or configured to generate a base payment graph comprising a plurality of nodes and a plurality of edges connecting the plurality of nodes, wherein each node represents an entity and each edge represents a probability that a real-time payment transaction may be conducted involving two entities that are connected by the edge, wherein the real-time payment transaction is artificially created. The at least one processor is also programmed or configured to generate a plurality of dynamic payment graphs based on the base payment graph. The at least one processor is further programmed or configured to insert patterns representing adversarial activity into the plurality of dynamic payment graphs. The at least one processor is further programmed or configured to perform an action associated with a machine learning technique using the plurality of dynamic payment graphs.

According to some non-limiting embodiments or aspects, provided is a computer program product for generating synthetic graphs that simulate real-time payment transactions. The computer program product includes at least one non-transitory computer-readable medium including one or more instructions that, when executed by at least one processor, cause the at least one processor to generate a base payment graph comprising a plurality of nodes and a plurality of edges connecting the plurality of nodes, wherein each node represents an entity and each edge represents a probability that a real-time payment transaction may be conducted involving two entities that are connected by the edge, wherein the real-time payment transaction is artificially created. The one or more instructions also cause the at least one processor to generate a plurality of dynamic payment graphs based on the base payment graph. The one or more instructions further cause the at least one processor to insert patterns representing adversarial activity into the plurality of dynamic payment graphs. The one or more instructions also cause the at least one processor to perform an action associated with a machine learning technique using the plurality of dynamic payment graphs.

Further non-limiting embodiments or aspects are set forth in the following numbered clauses:

Clause 1: A method, comprising: generating, with at least one processor, a base payment graph comprising a plurality of nodes and a plurality of edges connecting the plurality of nodes, wherein each node represents an entity and each edge represents a probability that a real-time payment transaction may be conducted involving two entities that are connected by the edge, and wherein the real-time payment transaction is artificially created; generating, with the at least one processor, a plurality of dynamic payment graphs based on the base payment graph; inserting, with the at least one processor, patterns representing adversarial activity into the plurality of dynamic payment graphs; and performing, with the at least one processor, an action associated with a machine learning technique using the plurality of dynamic payment graphs.

Clause 2: The method of clause 1, further comprising: assigning a plurality of account parameters to each node of the plurality of nodes; and assigning a plurality of transaction parameters to each edge of the plurality of edges.

Clause 3: The method of clause 1 or 2, wherein assigning the plurality of transaction parameters to each edge of the plurality of edges comprises: assigning a probability parameter and an interaction parameter to each edge of the plurality of edges.

Clause 4: The method of any of clauses 1-3, wherein generating the base payment graph comprises: generating the base payment graph based on a plurality of Barabasi-Albert graph structures.

Clause 5: The method of any of clauses 1-4, wherein generating the plurality of dynamic payment graphs comprises: sampling a first plurality of nodes and a first plurality of edges of the base payment graph to generate a first dynamic payment graph of the plurality of dynamic payment graphs, wherein the first dynamic payment graph is associated with a first time period.

Clause 6: The method of any of clauses 1-5, wherein the first dynamic payment graph comprises a second plurality of edges, wherein each edge of the second plurality of edges comprises real-time-payment transaction parameters, and wherein the real-time payment transaction parameters comprise: a time period of a real-time payment transaction; a transaction identifier of the real-time payment transaction; and a transaction amount of the real-time payment transaction.

Clause 7: The method of any of clauses 1-6, wherein sampling the first plurality of nodes and edges of the base payment graph to generate a first dynamic payment graph of the plurality of dynamic payment graphs comprises: sampling the first plurality of nodes and edges of the base payment graph based on: one or more account parameters of each node of the plurality of nodes; one or more transaction parameters of each edge of the plurality of edges; or any combination thereof.

Clause 8: A system, comprising: at least one processor; wherein the at least one processor is programmed or configured to: generate a base payment graph comprising a plurality of nodes and a plurality of edges connecting the plurality of nodes, wherein each node represents an entity and each edge represents a probability that a real-time payment transaction may be conducted involving two entities that are connected by the edge, and wherein the real-time payment transaction is artificially created; generate a plurality of dynamic payment graphs based on the base payment graph; insert patterns representing adversarial activity into the plurality of dynamic payment graphs; and perform an action associated with a machine learning technique using the plurality of dynamic payment graphs.

Clause 9: The system of clause 8, wherein the at least one processor is further programmed or configured to: assign a plurality of account parameters to each node of the plurality of nodes; and assign a plurality of transaction parameters to each edge of the plurality of edges.

Clause 10: The system of clause 8 or 9, wherein, when assigning the plurality of transaction parameters to each edge of the plurality of edges, the at least one processor is programmed or configured to: assign a probability parameter and an interaction parameter to each edge of the plurality of edges.

Clause 11: The system of any of clauses 8-10, wherein, when generating the base payment graph, the at least one processor is programmed or configured to: generate the base payment graph based on a plurality of Barabasi-Albert graph structures.

Clause 12: The system of any of clauses 8-11, wherein, when generating the plurality of dynamic payment graphs, the at least one processor is programmed or configured to: sample a first plurality of nodes and a first plurality of edges of the base payment graph to generate a first dynamic payment graph of the plurality of dynamic payment graphs, wherein the first dynamic payment graph is associated with a first time period.

Clause 13: The system of any of clauses 8-12, wherein the first dynamic payment graph comprises a second plurality of edges, wherein each edge of the second plurality of edges comprises real-time-payment transaction parameters, and wherein the real-time payment transaction parameters comprise: a time period of a real-time payment transaction; a transaction identifier of the real-time payment transaction; and a transaction amount of the real-time payment transaction.

Clause 14: The system of any of clauses 8-13, wherein, when sampling the first plurality of nodes and edges of the base payment graph to generate a first dynamic payment graph of the plurality of dynamic payment graphs, the at least one processor is programmed or configured to: sample the first plurality of nodes and edges of the base payment graph based on: one or more account parameters of each node of the plurality of nodes; one or more transaction parameters of each edge of the plurality of edges; or any combination thereof.

Clause 15: A computer program product, the computer program product comprising at least one non-transitory computer-readable medium including one or more instructions that, when executed by at least one processor, cause the at least one processor to: generate a base payment graph comprising a plurality of nodes and a plurality of edges connecting the plurality of nodes, wherein each node represents an entity and each edge represents a probability that a real-time payment transaction may be conducted involving two entities that are connected by the edge, and wherein the real-time payment transaction is artificially created; generate a plurality of dynamic payment graphs based on the base payment graph; insert patterns representing adversarial activity into the plurality of dynamic payment graphs; and perform an action associated with a machine learning technique using the plurality of dynamic payment graphs.

Clause 16: The computer program product of clause 15, wherein the one or more instructions further cause the at least one processor to: assign a plurality of account parameters to each node of the plurality of nodes; and assign a plurality of transaction parameters to each edge of the plurality of edges.

Clause 17: The computer program product of clause 15 or 16, wherein the one or more instructions that cause the at least one processor to assign the plurality of transaction parameters to each edge of the plurality of edges cause the at least one processor to: assign a probability parameter and an interaction parameter to each edge of the plurality of edges.

Clause 18: The computer program product of any of clauses 15-17, wherein the one or more instructions that cause the at least one processor to generate the base payment graph cause the at least one processor to: generate the base payment graph based on a plurality of Barabasi-Albert graph structures.

Clause 19: The computer program product of any of clauses 15-18, wherein the one or more instructions that cause the at least one processor to generate the plurality of dynamic payment graphs, cause the at least one processor to: sample a first plurality of nodes and a first plurality of edges of the base payment graph to generate a first dynamic payment graph of the plurality of dynamic payment graphs, wherein the first dynamic payment graph is associated with a first time period.

Clause 20: The computer program product of any of clauses 15-19, wherein the first dynamic payment graph comprises a second plurality of edges, wherein each edge of the second plurality of edges comprises real-time-payment transaction parameters, and wherein the real-time payment transaction parameters comprise: a time period of a real-time payment transaction; a transaction identifier of the real-time payment transaction; and a transaction amount of the real-time payment transaction.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present disclosure. As used in the specification and the claims, the singular form of “a,” “an,” and “the” include plural referents unless the context clearly dictates otherwise.

### BRIEF DESCRIPTION OF THE DRAWINGS

Additional advantages and details of the present disclosure are explained in greater detail below with reference to the exemplary embodiments that are shown in the accompanying schematic figures, in which:

FIG. 1 is a diagram of a non-limiting embodiment or aspect of an environment in which systems, devices, products, apparatus, and/or methods, described herein, may be implemented according to the principles of the present disclosure;

FIG. 2 is a diagram of a non-limiting embodiment or aspect of components of one or more devices of FIG. 1;

FIG. 3 is a flowchart of a non-limiting embodiment or aspect of a process for generating synthetic graphs that simulate real-time payment transactions;

FIGS. 4A-4C are diagrams of non-limiting embodiments or aspects of an implementation of a process for generating synthetic graphs that simulate real-time payment transactions;

FIGS. 5A-5D are diagrams of non-limiting embodiments or aspects of graphical representations of patterns representing fraud adversarial activity;

FIG. 5E is a diagram of a non-limiting embodiment or aspect of an implementation of inserting a pattern representing fraud adversarial activity;

FIGS. 6A-6D are diagrams of non-limiting embodiments or aspects of graphical representations of patterns representing money laundering adversarial activity; and

FIG. 6E is a diagram of a non-limiting embodiment or aspect of an implementation of inserting a pattern representing money laundering adversarial activity.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the present disclosure as it is oriented in the drawing figures. However, it is to be understood that the present disclosure may assume various alternative variations and step sequences, except where expressly specified to the contrary. It is also to be understood that the specific devices and processes shown in the attached drawings, and described in the following specification, are simply exemplary embodiments or aspects of the present disclosure. Hence, specific dimensions and other physical characteristics related to the embodiments or aspects of the embodiments disclosed herein are not to be considered as limiting unless otherwise indicated.

No aspect, component, element, structure, act, step, function, instruction, and/or the like used herein should be construed as critical or essential unless explicitly described as such. In addition, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. The phrase “based on” may also mean “in response to” where appropriate.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the terms “issuer institution,” “portable financial device issuer,” “issuer,” or “issuer bank” may refer to one or more entities that provide accounts to customers for conducting transactions (e.g., payment transactions), such as initiating credit and/or debit payments. For example, an issuer institution may provide an account identifier, such as a primary account number (PAN), to a customer that uniquely identifies one or more accounts associated with that customer. The account identifier may be embodied on a portable financial device, such as a physical financial instrument, e.g., a payment card, and/or may be electronic and used for electronic payments. The terms “issuer institution” and “issuer institution system” may also refer to one or more computer systems operated by or on behalf of an issuer institution, such as a server computer executing one or more software applications. For example, an issuer institution system may include one or more authorization servers for authorizing a transaction.

As used herein, the term “account identifier” may include one or more PANs, tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes. An issuer institution may be associated with a bank identification number (BIN) that uniquely identifies it.

As used herein, the term “account identifier” may include one or more types of identifiers associated with a user account (e.g., a PAN, a card number, a payment card number, a token, and/or the like). In some non-limiting embodiments or aspects, an issuer institution may provide an account identifier (e.g., a PAN, a token, and/or the like) to a user that uniquely identifies one or more accounts associated with that user. The account identifier may be embodied on a physical financial instrument (e.g., a portable financial instrument, a payment card, a credit card, a debit card, and/or the like) and/or may be electronic information communicated to the user that the user may use for electronic payments. In some non-limiting embodiments or aspects, the account identifier may be an original account identifier, where the original account identifier was provided to a user at the creation of the account associated with the account identifier. In some non-limiting embodiments or aspects, the account identifier may be an account identifier (e.g., a supplemental account identifier) that is provided to a user after the original account identifier was provided to the user. For example, if the original account identifier is forgotten, stolen, and/or the like, a supplemental account identifier may be provided to the user. In some non-limiting embodiments or aspects, an account identifier may be directly or indirectly associated with an issuer institution such that an account identifier may be a token that maps to a PAN or other type of identifier. Account identifiers may be alphanumeric, any combination of characters and/or symbols, and/or the like.

As used herein, the term “token” may refer to an identifier that is used as a substitute or replacement identifier for an account identifier, such as a PAN. Tokens may be associated with a PAN or other account identifiers in one or more data structures such that they can be used to conduct a transaction (e.g., a payment transaction) without directly using the account identifier, such as a PAN. In some examples, an account identifier, such as a PAN, may be associated with a plurality of tokens for different uses or different purposes.

As used herein, the term “merchant” may refer to one or more entities (e.g., operators of retail businesses that provide goods and/or services, and/or access to goods and/or services, to a user (e.g., a customer, a consumer, a customer of the merchant, and/or the like) based on a transaction (e.g., a payment transaction)). As used herein, the term “merchant system” may refer to one or more computer systems operated by or on behalf of a merchant, such as a server computer executing one or more software applications. As used herein, the term “product” may refer to one or more goods and/or services offered by a merchant.

As used herein, the term “point-of-sale (POS) device” may refer to one or more devices, which may be used by a merchant to initiate transactions (e.g., a payment transaction), engage in transactions, and/or process transactions. For example, a POS device may include one or more computers, peripheral devices, card readers, near-field communication (NFC) receivers, radio frequency identification (RFID) receivers, and/or other contactless transceivers or receivers, contact-based receivers, payment terminals, computers, servers, input devices, and/or the like.

As used herein, the term “transaction service provider” may refer to an entity that receives transaction authorization requests from merchants or other entities and provides guarantees of payment, in some cases through an agreement between the transaction service provider and an issuer institution. In some non-limiting embodiments or aspects, a transaction service provider may include a credit card company, a debit card company, a payment network such as Visa®, MasterCard®, American Express®, or any other entity that processes transaction. As used herein, the term “transaction service provider system” may refer to one or more computer systems operated by or on behalf of a transaction service provider, such as a transaction service provider system executing one or more software applications. A transaction service provider system may include one or more processors and, in some non-limiting embodiments or aspects, may be operated by or on behalf of a transaction service provider.

As used herein, the term “acquirer” may refer to an entity licensed by the transaction service provider and approved by the transaction service provider to originate transactions (e.g., payment transactions) using a portable financial device associated with the transaction service provider. As used herein, the term “acquirer system” may also refer to one or more computer systems, computer devices, and/or the like operated by or on behalf of an acquirer. The transactions the acquirer may originate may include payment transactions (e.g., purchases, original credit transactions (OCTs), account funding transactions (AFTs), and/or the like). In some non-limiting embodiments or aspects, the acquirer may be authorized by the transaction service provider to assign merchant or service providers to originate transactions using a portable financial device of the transaction service provider. The acquirer may contract with payment facilitators to enable the payment facilitators to sponsor merchants. The acquirer may monitor compliance of the payment facilitators in accordance with regulations of the transaction service provider. The acquirer may conduct due diligence of the payment facilitators and ensure proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by an acquirer's payment facilitator, and/or the like. In some non-limiting embodiments or aspects, an acquirer may be a financial institution, such as a bank.

As used herein, the terms “electronic wallet,” “electronic wallet mobile application,” and “digital wallet” may refer to one or more electronic devices and/or one or more software applications configured to initiate and/or conduct transactions (e.g., payment transactions, electronic payment transactions, and/or the like). For example, an electronic wallet may include a user device (e.g., a mobile device) executing an application program and server-side software and/or databases for maintaining and providing transaction data to the user device. As used herein, the term “electronic wallet provider” may include an entity that provides and/or maintains an electronic wallet and/or an electronic wallet mobile application for a user (e.g., a customer). Examples of an electronic wallet provider include, but are not limited to, Google Pay®, Android Pay®, Apple Pay®, and Samsung Pay®. In some non-limiting examples, a financial institution (e.g., an issuer institution) may be an electronic wallet provider. As used herein, the term “electronic wallet provider system” may refer to one or more computer systems, computer devices, servers, groups of servers, and/or the like operated by or on behalf of an electronic wallet provider.

As used herein, the term “portable financial device” may refer to a payment device, an electronic payment device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a personal digital assistant (PDA), a pager, a security card, a computer, an access card, a wireless terminal, a transponder, and/or the like. In some non-limiting embodiments or aspects, the portable financial device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like, operated by or on behalf of a payment gateway and/or to a payment gateway itself. The term “payment gateway mobile application” may refer to one or more electronic devices and/or one or more software applications configured to provide payment services for transactions (e.g., payment transactions, electronic payment transactions, and/or the like).

As used herein, the term “client device” may refer to one or more devices (e.g., client-side devices) or one or more systems (e.g., client-side systems), which are remote from a server, used to access a functionality provided by the server. For example, a client device may include one or more computing devices (e.g., one or more computers, computing machines, processors, electronic computers, information processing systems, and/or the like), portable computers, tablet computers, cellular phones, smartphones, wearable devices (e.g., watches, glasses, lenses, clothing, and/or the like), PDAs, and/or the like.

As used herein, the term “server” may refer to one or more devices that provide a functionality to one or more devices (e.g., one or more client devices) via a network (e.g., a public network, a private network, the Internet, and/or the like). For example, a server may include one or more computing devices.

As used herein, the term “system” may refer to one or more devices, such as one or more processors, servers, client devices, computing devices that include software applications, and/or the like.

In some non-limiting embodiments or aspects, reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

Non-limiting embodiments or aspects of the present disclosure are directed to systems, methods, and computer program products for generating synthetic graphs that simulate real-time payment transactions. In some non-limiting embodiments or aspects, a computer-implemented method may include a graph generation system that generates a base payment graph that includes a plurality of nodes and a plurality of edges connecting the plurality of nodes, where each node represents an entity and each edge represents a probability that a real-time payment transaction may be conducted involving two entities that are connected by the edge and the real-time payment transaction is artificially created, generate a plurality of dynamic payment graphs based on the base payment graph, inserts patterns representing adversarial activity into the plurality of dynamic payment graphs, and performs an action associated with a machine learning technique using the plurality of dynamic payment graphs.

In this way, the graph generation system may provide a dataset that represents actual real-time payment transactions. Additionally, machine learning techniques can be developed to provide risk management and decision making with regard to real-time payment transactions.

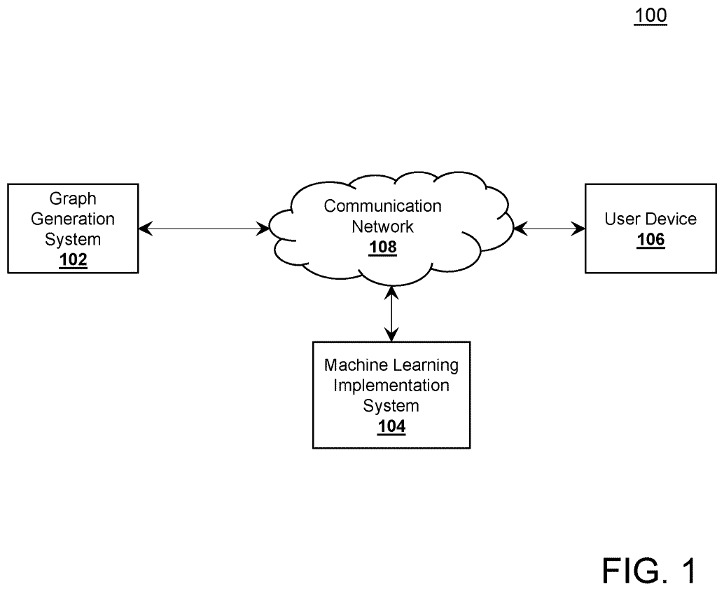

Referring now to FIG. 1, FIG. 1 is a diagram of an example environment 100 in which devices, systems, and/or methods, described herein, may be implemented. As shown in FIG. 1, environment 100 includes graph generation system 102, machine learning implementation system 104, user device 106, and communication network 108. Graph generation system 102, machine learning implementation system 104, and/or user device 106 may interconnect (e.g., establish a connection to communicate) via wired connections, wireless connections, or a combination of wired and wireless connections.

Graph generation system 102 may include one or more computing devices configured to communicate with machine learning implementation system 104 and/or user device 106 via communication network 108. For example, graph generation system 102 may include a server, a group of servers, and/or other like devices. In some non-limiting embodiments or aspects, graph generation system 102 may be associated with a transaction service provider system, as described herein. Additionally or alternatively, graph generation system 102 may be associated with a transaction service provider system, an issuer system, an acquirer system, a merchant system, a payment gateway system, and/or the like. In some non-limiting embodiments or aspects, graph generation system 102 may be in communication with a data storage device, which may be local or remote to graph generation system 102. In some non-limiting embodiments or aspects, graph generation system 102 may be capable of receiving information from, storing information in, transmitting information to, and/or searching information stored in the data storage device.

Machine learning implementation system 104 may include a computing device configured to communicate with graph generation system 102 and/or user device 106 via communication network 108. For example, machine learning implementation system 104 may include a computing device, such as a server, a group of servers, and/or other like devices. In some non-limiting embodiments or aspects, machine learning implementation system 104 may be associated with a transaction service provider system, an issuer system, an acquirer system, a merchant system, a payment gateway system, and/or the like. Additionally or alternatively, machine learning implementation system 104 may generate (e.g., train, validate, retrain, and/or the like), store, and/or implement (e.g., operate, provide inputs to and/or outputs from, and/or the like) one or more machine learning models. In some non-limiting embodiments or aspects, machine learning implementation system 104 may be a component of graph generation system 102.

User device 106 may include a computing device configured to communicate with graph generation system 102 and/or machine learning implementation system 104 via communication network 108. For example, machine learning implementation system 104 may include a computing device, such as a desktop computer, a portable computer (e.g., tablet computer, a laptop computer, and/or the like), a mobile device (e.g., a cellular phone, a smartphone, a personal digital assistant, a wearable device, and/or the like), and/or other like devices. In some non-limiting embodiments or aspects, user device 106 may be associated with a user (e.g., an individual operating user device 106).

Communication network 108 may include one or more wired and/or wireless networks. For example, communication network 108 may include a cellular network (e.g., a long-term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN) and/or the like), a private network, an ad hoc network, an intranet, the Internet, a fiber optic-based network, a cloud computing network, and/or the like, and/or a combination of some or all of these or other types of networks.

The number and arrangement of devices and networks shown in FIG. 1 are provided as an example. There may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally or alternatively, a set of devices (e.g., one or more devices) of environment 100 may perform one or more functions described as being performed by another set of devices of environment 100.

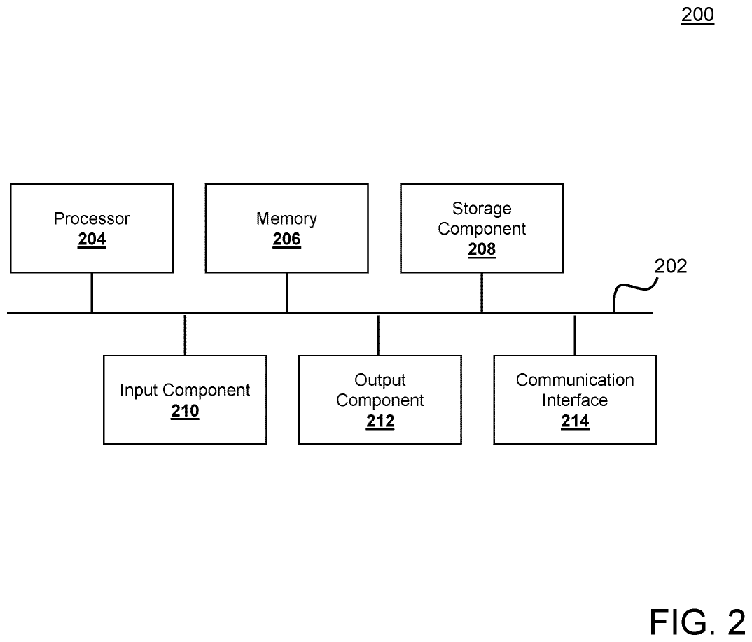

Referring now to FIG. 2, FIG. 2 is a diagram of example components of a device 200. Device 200 may correspond to graph generation system 102 (e.g., one or more devices of graph generation system 102), machine learning implementation system 104 (e.g., one or more devices of machine learning implementation system 104), and/or user device 106. In some non-limiting embodiments or aspects, graph generation system 102, machine learning implementation system 104, and/or user device 106 may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments or aspects, processor 204 may be implemented in hardware, software, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read-only memory (ROM), and/or another type of dynamic or static storage memory (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 2 are provided as an example. In some non-limiting embodiments or aspects, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

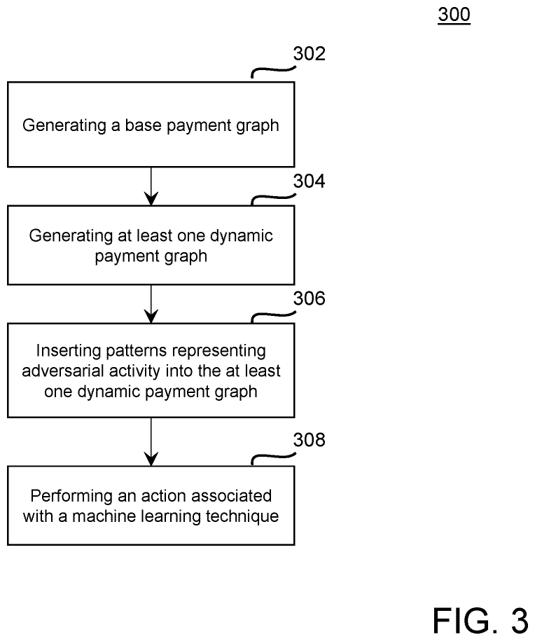

Referring now to FIG. 3, FIG. 3 is a flowchart of a non-limiting embodiment or aspect of a process 300 for generating synthetic graphs that simulate real-time payment transactions. In some non-limiting embodiments or aspects, one or more of the steps of process 300 may be performed (e.g., completely, partially, etc.) by graph generation system 102 (e.g., one or more devices of graph generation system 102). In some non-limiting embodiments or aspects, one or more of the steps of process 300 may be performed (e.g., completely, partially, etc.) by another device or a group of devices separate from or including graph generation system 102 (e.g., one or more devices of graph generation system 102), machine learning implementation system 104 (e.g., one or more devices of machine learning implementation system 104), user device 106, and/or communication network 108 (e.g., one or more devices of communication network 108).

As shown in FIG. 3, at step 302, process 300 includes generating a base payment graph with a plurality of nodes and a plurality of edges connecting the plurality of nodes. For example, graph generation system 102 may generate the base payment graph with a plurality of nodes and a plurality of edges connecting the plurality of nodes. In some non-limiting embodiments or aspects, the plurality of nodes may include millions of nodes and the plurality of edges may include millions of edges. In some non-limiting embodiments or aspects, each node may represent an entity (e.g., an individual, such as a customer, a business, such as a merchant, and/or the like) or an account of an entity. In some non-limiting embodiments or aspects, each edge may include parameters that represent a probability that a real-time payment transaction may be conducted involving the two entities that are connected by the edge. The real-time payment transaction may include an artificially created real-time payment transaction. For example, the real-time payment transaction may include transaction data that is based on a payment transaction that took place in the real-world, however, the transaction data is not the same as transaction data associated with the payment transaction that took place in the real-world.

In some non-limiting embodiments or aspects, graph generation system 102 may assign graph attributes to the base payment graph to simulate a real-world payment graph. For example, graph generation system 102 may assign the graph attributes to the base payment graph where the graph attributes are based on realistic graph statistics regarding real-time payment transactions. In some non-limiting embodiments or aspects, graph generation system 102 may receive the graph attributes from user device 106.

In some non-limiting embodiments or aspects, graph generation system 102 may assign a plurality of account parameters to each node of the plurality of nodes. For example, graph generation system 102 may assign an account number, an account identifier, a bank identifier, a routing number, and/or the like, to each node. In some non-limiting embodiments or aspects, graph generation system 102 may assign a plurality of transaction parameters to each edge of the plurality of edges. For example, graph generation system 102 may assign a probability parameter to each edge of the plurality of edges. In some non-limiting embodiments or aspects, the probability parameter may indicate a probability that a real-time payment transaction may occur involving two entities that are connected by the edge. Additionally or alternatively, graph generation system 102 may assign an interaction parameter to each edge of the plurality of edges. For example, graph generation system 102 may assign a parameter indicating the edge is associated with a customer-to-customer (C2C) interaction, a customer-to-business (C2B) interaction, a business-to-customer (B2C) interaction, or a business-to-business (B2B) interaction. In some non-limiting embodiments or aspects, graph generation system 102 may receive the plurality of account parameters and/or the plurality of transaction parameters from user device 106.

In some non-limiting embodiments or aspects, graph generation system 102 may generate the base payment graph based on a plurality of Barabasi-Albert graph structures. For example, graph generation system 102 may generate the base payment graph by combining a plurality of Barabasi-Albert graph structures.

As further shown in FIG. 3, at step 304, process 300 includes generating at least one dynamic payment graph. For example, graph generation system 102 may generate the at least one dynamic payment graph based on the base payment graph.

In some non-limiting embodiments or aspects, graph generation system 102 may sample a plurality of nodes and a plurality of edges of the base payment graph to generate a dynamic payment graph. In some non-limiting embodiments or aspects, graph generation system 102 may sample a plurality of nodes and a plurality of edges of the base payment graph to generate a predetermined number of dynamic payment graphs.

In some non-limiting embodiments or aspects, graph generation system 102 may sample a first plurality of nodes and a first plurality of edges of the base payment graph to generate a first dynamic payment graph of a plurality of dynamic payment graphs. The first dynamic payment graph may be associated with a first time period. In some non-limiting embodiments or aspects, graph generation system 102 may sample a second plurality of nodes and a second plurality of edges of the base payment graph to generate a second dynamic payment graph of the plurality of dynamic payment graphs. The second dynamic payment graph may be associated with a second time period. Graph generation system 102 may sample the base payment graph a predetermined number of times to generate a predetermined number of dynamic payment graphs (e.g., the plurality of dynamic payment graphs), which are each associated with a time period (e.g., a different time period). In some non-limiting embodiments or aspects, each dynamic payment graph includes a plurality of edges and each edge of the plurality of edges may include real-time-payment transaction parameters. In some non-limiting embodiments or aspects, the real-time-payment transaction parameters may include a time period of a real-time-payment transaction, a transaction identifier of the real-time-payment transaction, and/or a transaction amount of the real-time-payment transaction. In some non-limiting embodiments or aspects, graph generation system 102 may sample a plurality of nodes and a plurality of edges of the base payment graph based on one or more account parameters of each node of the plurality of nodes and/or one or more transaction parameters of each edge of the plurality of edges.

As further shown in FIG. 3, at step 306, process 300 includes inserting patterns representing adversarial activity into the at least one dynamic payment graph. For example, graph generation system 102 may insert one or more patterns representing adversarial (e.g., illegitimate, criminal, illicit, fraudulent, etc.) activity into the at least one dynamic payment graph. In some non-limiting embodiments or aspects, a pattern representing adversarial activity may include a graphical representation of activity (e.g., criminal activity) associated with fraud. For example, the pattern may correspond to transactions between entities that indicate an account takeover, a business email compromise, an authorized push payment scheme, and/or a pyramid scheme. Additionally or alternatively, a pattern representing adversarial activity may include a graphical representation of activity (e.g., criminal activity) associated with money laundering. For example, the pattern may correspond to transactions between entities that indicate an illegal flow of funds to an entity, a Ponzi scheme, a circular flow of funds, and an illegal flow of funds during a time period to an entity.

As further shown in FIG. 3, at step 308, process 300 includes performing an action associated with a machine learning technique. For example, graph generation system 102 may perform the action associated with the machine learning technique. In some non-limiting embodiments or aspects, graph generation system 102 may transmit a dynamic payment graph to machine learning implementation system 104 so that machine learning implementation system 104 may carry out machine learning techniques on the dynamic payment graph. In some non-limiting embodiments or aspects, graph generation system 102 may carry out machine learning techniques on the dynamic payment graph. In some non-limiting embodiments or aspects, graph generation system 102 may detect a transaction, an account, and/or an accountholder, as being associated with criminal behavior, for example, fraud and/or money laundering behavior based on determining that a pattern of adversarial activity is present (e.g., present in a base payment graph).

In some non-limiting embodiments or aspects, graph generation system 102 may generate a dataset (e.g., a training dataset) based on inserting the patterns representing adversarial activity into the at least one dynamic payment graph. In one example, graph generation system 102 may generate the dataset that includes a plurality of transactions that represent payment transactions involving adversarial activity, where the plurality of transactions are based on the at least one dynamic payment graph. In some non-limiting embodiments or aspects, graph generation system 102 may generate a machine learning model based on the dataset. For example, graph generation system 102 may train and/or validate the machine learning model based on the dataset.

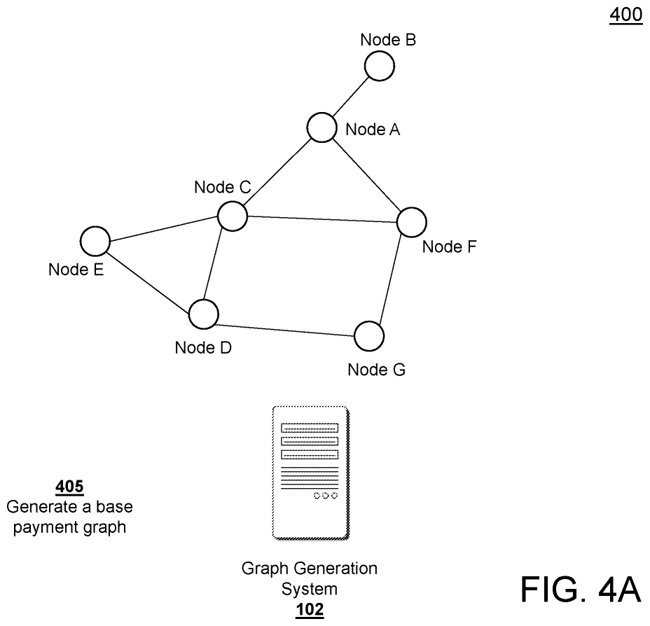

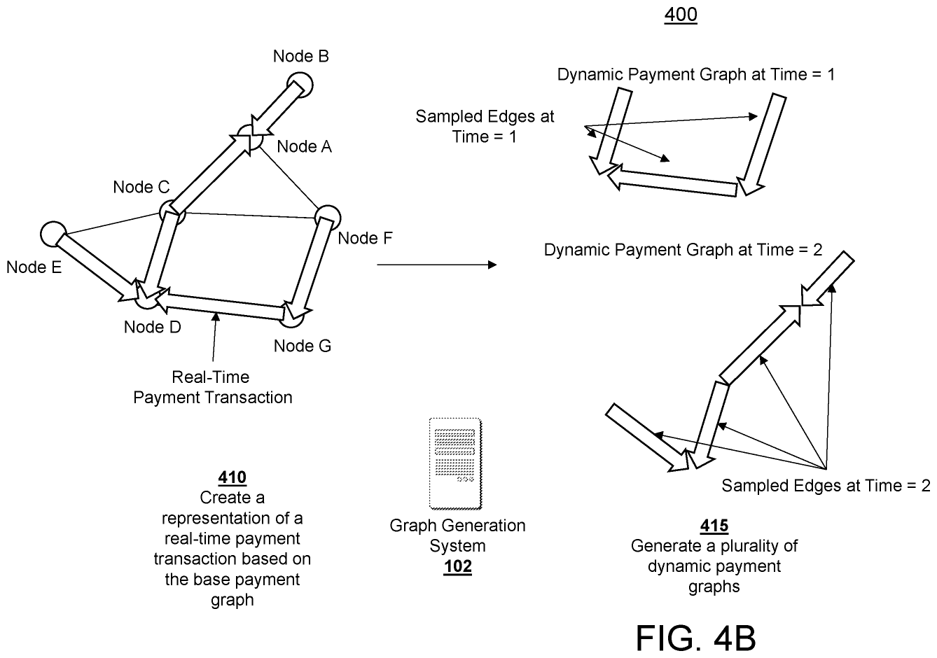

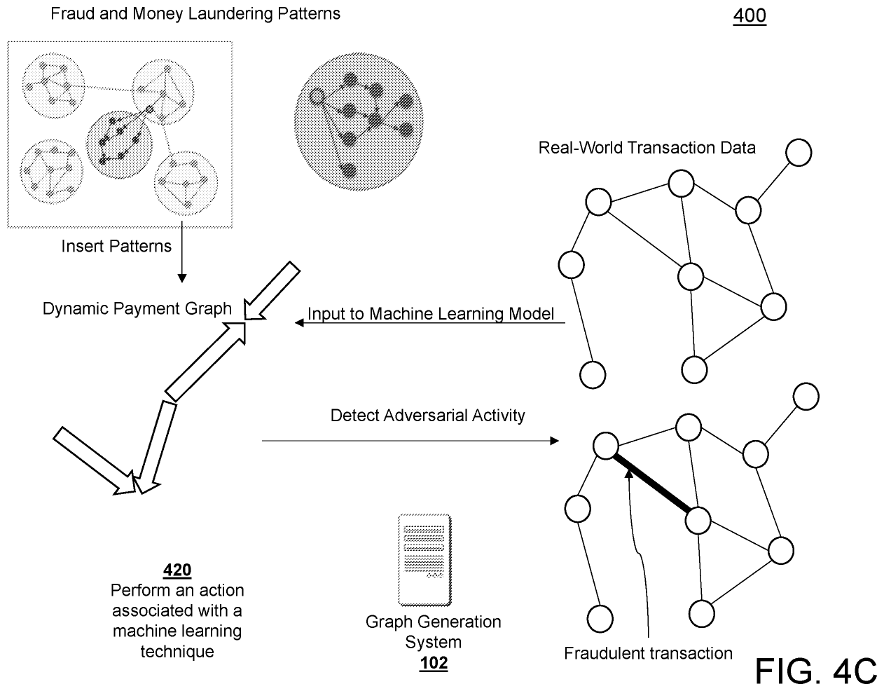

Referring now to FIGS. 4A-4C, FIGS. 4A-4C are diagrams of non-limiting embodiments or aspects of an implementation 400 of a process (e.g., process 300) for generating synthetic graphs that simulate real-time payment transactions. As shown in FIGS. 4A-4C, implementation 400 may include graph generation system 102 performing the steps of the process.

As shown by reference number 405 in FIG. 4A, graph generation system 102 may generate a base payment graph. In some non-limiting embodiments or aspects, the base payment graph may include a plurality of nodes and a plurality of edges connecting the plurality of nodes. In some non-limiting embodiments or aspects, nodes may represent business accounts and/or customer accounts. In some non-limiting embodiments or aspects, edges may represent C2C payments, C2B payments, B2C payments, and/or B2B payments. The number of nodes of the plurality of nodes in a base payment graph may be a user parameter. In some non-limiting embodiments or aspects, the base payment graph may include parameters, such as average node degree, start and end date for transaction data, upper and lower limit of number of transactions per day, and/or the like. In some non-limiting embodiments or aspects, the number of edges of the plurality of edges may be based on the number of nodes of the plurality of nodes and/or other parameters.

In some non-limiting embodiments or aspects, graph generation system 102 may assign graph attributes to the base graph based on realistic graph statistics. In some non-limiting embodiments or aspects, graph attributes may be static graph attributes or dynamic graph attributes. For example, graph generation system 102 may assign a plurality of static graph attributes to each node of the plurality of nodes, such as account numbers, account names, routing numbers, bank identification numbers, and/or the like. In some non-limiting embodiments or aspects, graph generation system 102 may assign graph attributes to the base payment graph to simulate a real-world payment graph. For example, graph generation system 102 may assign the graph attributes based on realistic graph statistics regarding real-time payment transactions.

In some non-limiting embodiments or aspects, graph generation system 102 may generate the base payment graph based on a plurality of Barabasi-Albert graph structures. For example, graph generation system 102 may generate the base payment graph by combining a plurality of Barabasi-Albert graph structures. In some non-limiting embodiments or aspects, graph generation system 102 generating the base payment graph based on a plurality of Barabasi-Albert graph structures may increase the clustering coefficient of the base payment graph. In some non-limiting embodiments or aspects, graph generation system 102 may generate the base payment graph based on a combination of different graph structures, such as a karate club graph structure and a Barabasi-Albert graph structure. In some non-limiting embodiments or aspects, graph generation system 102 may generate the base payment graph based on a ratio of different graph structures (e.g., according to a customizable parameter of a ratio of different graph structures).

In some non-limiting embodiments or aspects, each node of the plurality of nodes may represent an entity and each edge of the plurality of edges may represent a probability that a real-time payment transaction may be conducted involving two entities that are connected by the edge. In some non-limiting embodiments or aspects, graph generation system 102 may assign a plurality of static graph attributes to each edge of the plurality of edges. In some non-limiting embodiments or aspects, static graph attributes may include account parameters. In some non-limiting embodiments or aspects, static graph attributes may include transaction parameters. In some non-limiting embodiments or aspects, graph generation system 102 may assign a plurality of account parameters to each node of the plurality of nodes. In some non-limiting embodiments or aspects, graph generation system 102 may assign a plurality of transaction parameters to each edge of the plurality of edges. For example, graph generation system 102 may assign, to each edge of the plurality of edges, a transaction type (e.g., peer-to-business (P2B), peer-to-peer (P2P), and/or the like) and a probability that a real-time payment transaction may be conducted involving two entities that are connected by the edge. In some non-limiting embodiments or aspects, graph generation system 102 may assign a probability parameter and an interaction parameter to each edge of the plurality of edges.

As shown by reference number 410 in FIG. 4B, graph generation system 102 may create a representation of a real-time payment transaction based on the base payment graph. In some non-limiting embodiments or aspects, graph generation system 102 may artificially create a real-time payment transaction based on the plurality of nodes and the plurality of edges of the base payment graph. In some non-limiting embodiments or aspects, graph generation system 102 may artificially create a real-time payment transaction based on the plurality of graph attributes assigned to each node of the plurality of nodes and each edge of the plurality of edges. For example, graph generation system 102 may artificially create a real-time payment transaction along a selected edge from one selected node to another selected node based on the attributes assigned to the selected nodes and the attributes assigned to the selected edge.

As shown by reference number 415 in FIG. 4B, graph generation system 102 may generate a plurality of dynamic payment graphs. In some non-limiting embodiments or aspects, graph generation system 102 may generate a plurality of dynamic payment graphs based on the base payment graph. In some non-limiting embodiments or aspects, graph generation system 102 may sample a first plurality of nodes and a first plurality of edges of the base payment graph to generate a first dynamic payment graph of the plurality of payments graphs. In some non-limiting embodiments or aspects, the first dynamic payment graph may be associated with a first time period. In some non-limiting embodiments or aspects, graph generation system 102 may sample a plurality of nodes and a plurality of edges of the base payment graph at a plurality of discrete time periods within a time sequence (e.g., duration, amount of time, etc.). For example, graph generation system 102 may generate a plurality of dynamic payment graphs by sampling a plurality of nodes and a plurality of edges of the base payment graph at a discrete time period equal to 1 and by sampling a plurality of nodes and a plurality of edges of the base payment graph at a discrete time period equal to 2.

In some non-limiting embodiments or aspects, the first dynamic payment graph may include a second plurality of edges. In some non-limiting embodiments or aspects, each edge of the second plurality of edges may include real-time-payment transaction parameters. In some non-limiting embodiments or aspects, the real-time payment transaction parameters may include a time period of a real-time payment transaction, a transaction identifier of the real-time payment transaction, and a transaction amount of the real-time-payment transaction. In some non-limiting embodiments or aspects, graph generation system 102 may sample a plurality of nodes and a plurality of edges of the base payment graph where graph generation system 102 has artificially created real-time payment transactions. In this way, graph generation system 102 may generate a plurality of dynamic payment graphs containing the plurality of graph attributes assigned to each node of the plurality of nodes and each edge of the plurality of edges based on sampling a plurality of nodes and a plurality of edges of the base payment graph.

In some non-limiting embodiments or aspects, graph generation system 102 may sample the plurality of edges of the base payment graph based on the attributes assigned to each node of the plurality of nodes and each edge of the plurality of edges. For example, graph generation system 102 may sample the plurality of edges of the base payment graph based on weights assigned to edges (e.g., sampling edges with higher weights). In some non-limiting embodiments or aspects, graph generation system 102 may assign dynamic graph attributes (e.g., transaction amount, transaction time, etc.) to each edge of the plurality of edges of the plurality of dynamic payment graphs based on the static graph attributes assigned to each node and each edge. For example, graph generation system 102 may assign a different transaction amount to each edge of the plurality of edges where the edges are assigned different static graph attributes (e.g., a B2B edge versus a C2C edge, etc.). In some non-limiting embodiments or aspects, graph generation system 102 may assign dynamic graph attributes to each edge of the plurality of edges of the plurality of dynamic payment graphs based on a predefined statistical distribution. In some non-limiting embodiments or aspects, sampling the first plurality of nodes and edges of the base payment graph to generate a first dynamic payment graph of the plurality of dynamic payment graphs may include sampling the first plurality of nodes and edges of the base payment graph based on one or more account parameters of each node of the plurality of nodes, one or more transaction parameters of each edge of the plurality of edges, or any combination thereof.

As shown by reference number 420 in FIG. 4C, graph generation system 102 may perform an action associated with a machine learning technique. In some non-limiting embodiments or aspects, graph generation system 102 may perform an action associated with a machine learning technique based on the plurality of dynamic payment graphs. For example, graph generation system 102 may detect one or more fraudulent transactions within a plurality of transactions based on the dynamic payment graph. As a further example, graph generation system 102 may detect one or more money laundering transactions within a plurality of transactions using the dynamic payment graph.

In some non-limiting embodiments or aspects, graph generation system 102 may train one or more machine learning models using the plurality of dynamic payment graphs. In some non-limiting embodiments or aspects, the dynamic payment graphs may include patterns representing adversarial activity. In some non-limiting embodiments or aspects, the one or more machine learning models may include one or more unsupervised machine learning models (e.g., artificial neural network, autoencoder, and/or the like). In some non-limiting embodiments or aspects, graph generation system 102 may provide real-world transaction data as input to one or more trained machine learning models for performing an action. For example, graph generation system 102 may provide real-world transaction data to one or more trained machine learning models such that the one or more machine learning models can detect adversarial activity, such as fraudulent transactions or money laundering transactions.

In some non-limiting embodiments or aspects, graph generation system 102 may receive a prediction output from the one or more machine learning models. In some non-limiting embodiments or aspects, graph generation system 102 may perform an action associated with a machine learning technique based on the prediction output. For example, graph generation system 102 may flag a transaction as fraudulent based on the prediction output.

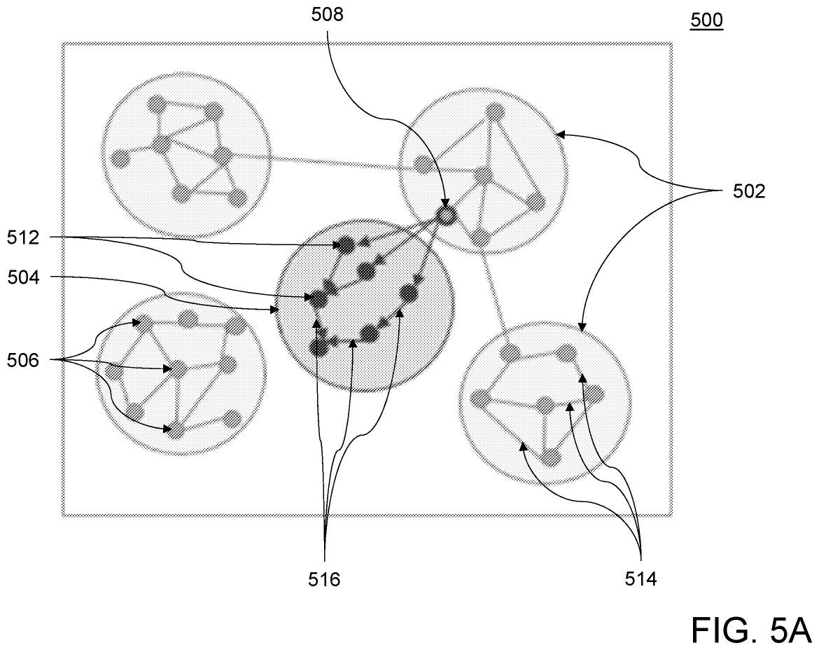

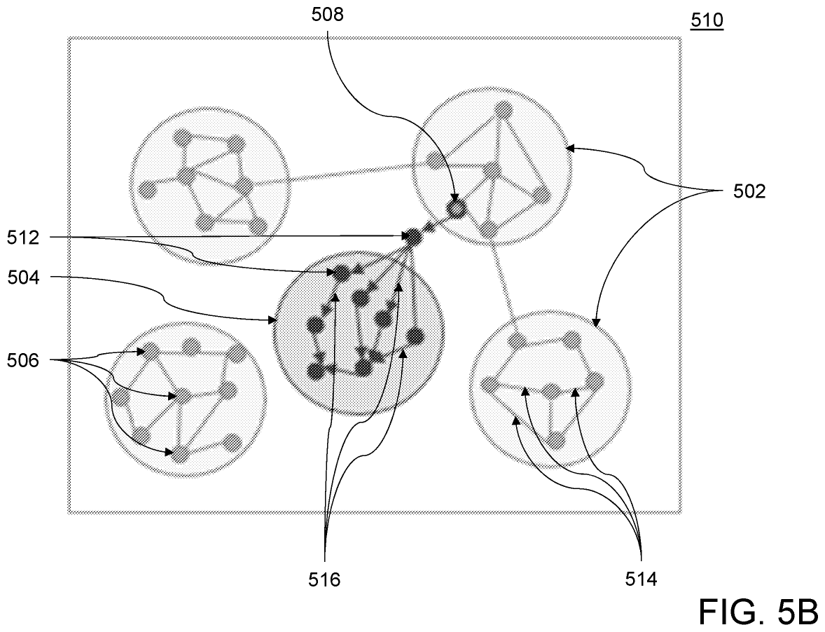

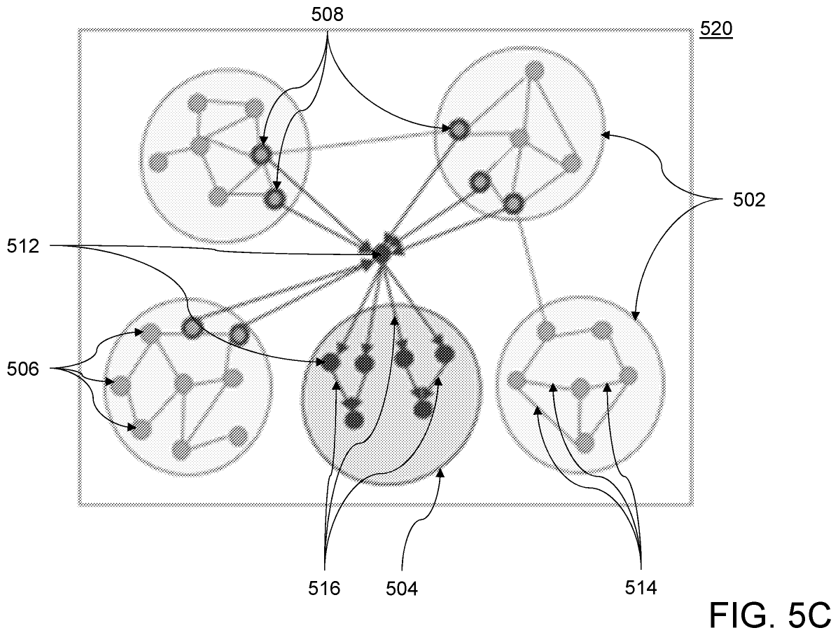

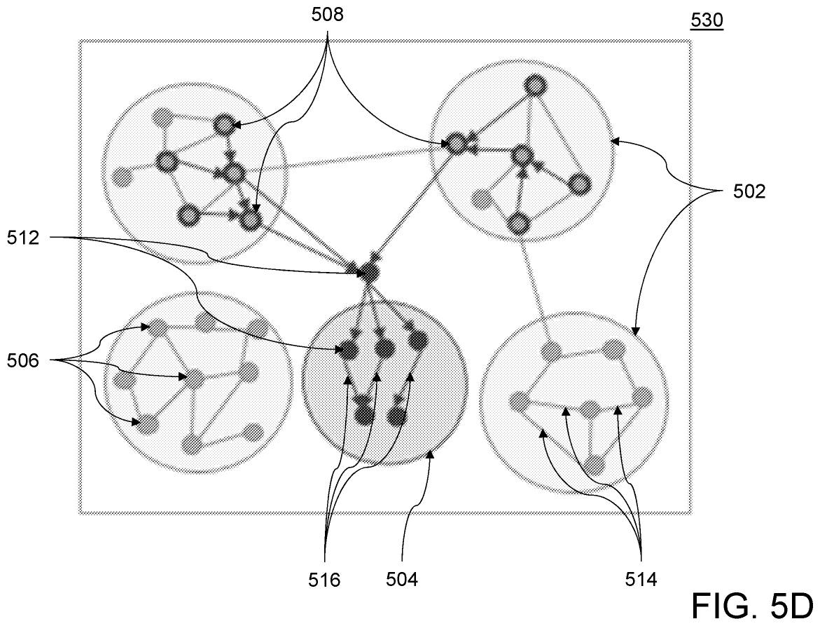

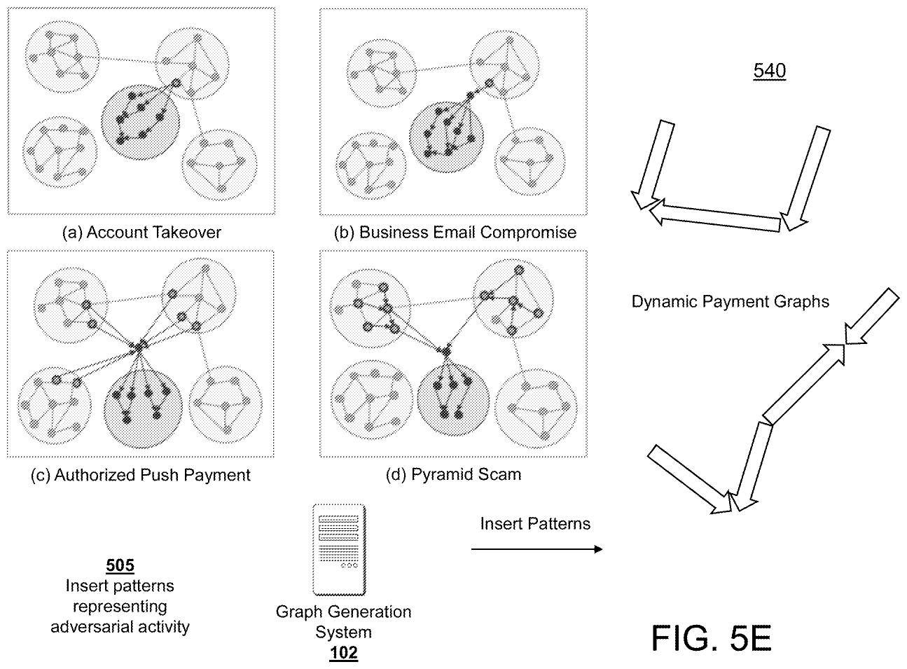

Referring now to FIGS. 5A-5D, FIGS. 5A-5D are diagrams of non-limiting embodiments or aspects of graphical representations of patterns representing fraud adversarial activity. As shown in FIGS. 5A-5D, graphical representations of patterns representing fraud may include account takeover (“ATO”) pattern 500, business email compromise (“BEC”) pattern 510, authorized push payment (“APP”) pattern 520, and pyramid scam pattern 530.

As shown in FIG. 5A, ATO pattern 500 may include payment communities 502, money mule communities 504, legitimate account nodes 506 (e.g., a plurality of legitimate accounts, legitimate accounts, etc.), victim account nodes 508 (e.g., a plurality of victim accounts, victim accounts, etc.), malicious account nodes 512 (e.g., a plurality of malicious accounts, malicious accounts, etc.), account connections 514, and fund transfer directions 516.

In some non-limiting embodiments or aspects, a payment community may include a group of account nodes (e.g., legitimate account nodes 506). In some non-limiting embodiments or aspects, payment communities 502 may contain legitimate account nodes 506, victim account nodes 508, and/or account connections 514. In some non-limiting embodiments or aspects, payment communities 502 may be connected to other payment communities 502 via account connections 514 between legitimate account nodes 506 in each of the connected payment communities 502. In some non-limiting embodiments or aspects, a money mule community may include a group of malicious account nodes (e.g., malicious account nodes 512). In some non-limiting embodiments or aspects, money mule communities 504 may contain malicious account nodes 512 and fund transfer directions 516. In some non-limiting embodiments or aspects, legitimate account nodes 506 may include a representation of an account that participates in transactions that are normal transactions (e.g., everyday C2C, C2B transactions, etc.) that are not based on adversarial activity.

In some non-limiting embodiments or aspects, a victim account node may include a representation of an account which has been accessed by a malicious account and may participate in transactions with malicious accounts through adversarial activity. In some non-limiting embodiments or aspects, a victim account node may include a representation of an account which may participate in transactions with other victim accounts based on adversarial activity of malicious accounts. In some non-limiting embodiments or aspects, victim account nodes 508 may include legitimate account nodes 506 which have been accessed by at least one malicious account node 512. In some non-limiting embodiments or aspects, legitimate account nodes 506 may be the same as or similar to victim account nodes 508.

In some non-limiting embodiments or aspects, malicious account nodes 512 may include a representation of an account which gains access to a victim account and may participate in transactions with the victim account based on adversarial activity. In some non-limiting embodiments or aspects, malicious account nodes 512 may include a representation of an account which may participate in transactions with other malicious accounts.

In some non-limiting embodiments or aspects, account connections 514 may include a representation of transactions that are normal transactions (e.g., everyday C2C, C2B transactions, etc.) that are not based on adversarial activity. In some non-limiting embodiments or aspects, fund transfer directions 516 may include a representation of transactions from a victim account to a malicious account that are based on adversarial activity. In some non-limiting embodiments or aspects, fund transfer directions 516 may begin in payment community 502 and terminate in money mule community 504.

In some non-limiting embodiments or aspects, ATO pattern 500 may include graphical representations of interactions and/or transactions (e.g., connections) between legitimate account nodes 506 and/or victim account nodes 508 via account connections 514. Graphical representation of connections between legitimate account nodes 506 and/or victim account nodes 508 is represented by account connections 514. In some non-limiting embodiments or aspects, ATO pattern 500 may include graphical representations of malicious account nodes 512 gaining access to legitimate account nodes 506 via victim account nodes 508. Where at least one malicious account node 512 gains access to at least one legitimate account node 506, the at least one legitimate account node 506 may be a victim account node 508. In some non-limiting embodiments or aspects, ATO pattern 500 may include graphical representations of malicious account nodes 512 transferring funds from victim account nodes 508 to malicious account nodes 512 via fund transfer directions 516. Graphical representation of fund and/or data transfer is shown by fund transfer directions 516. In some non-limiting embodiments or aspects, ATO pattern 500 may include graphical representations of malicious account nodes 512 transferring funds to other malicious account nodes 512 via fund transfer directions 516. In some non-limiting embodiments or aspects, ATO pattern 500 may include one victim account node 508. In some non-limiting embodiments or aspects, ATO pattern 500 may include graphical representations of one victim account node 508 transferring funds to one or more malicious account nodes 512 via fund transfer directions 516.

As shown in FIG. 5B, BEC pattern 510 may include payment communities 502, money mule communities 504, legitimate account nodes 506, victim account nodes 508, malicious account nodes 512, account connections 514, and fund transfer directions 516. In some non-limiting embodiments or aspects, payment communities 502 may include legitimate account nodes 506, victim account nodes 508, and/or account connections 514. In some non-limiting embodiments or aspects, payment communities 502 may be connected to other payment communities 502 via account connections 514 between legitimate account nodes 506 in each of the connected payment communities 502. In some non-limiting embodiments or aspects, money mule communities 504 may include malicious account nodes 512 and fund transfer directions 516. In some non-limiting embodiments or aspects, fund transfer directions 516 may begin in payment community 502 and terminate in money mule community 504. In some non-limiting embodiments or aspects, victim account nodes 508 may include legitimate account nodes 506 which have been accessed by one malicious account node 512. In some non-limiting embodiments or aspects, legitimate account nodes 506 may be the same as or similar to victim account nodes 508.

In some non-limiting embodiments or aspects, BEC pattern 510 may include graphical representations of interactions and/or transactions (e.g., connections) between legitimate account nodes 506 and/or victim account nodes 508 via account connections 514. Graphical representation of connections between legitimate account nodes 506 and/or victim account nodes 508 is shown by account connections 514. In some non-limiting embodiments or aspects, BEC pattern 510 may include graphical representations of malicious account nodes 512 gaining access to legitimate account nodes 506 via victim account nodes 508. Where at least one malicious account node 512 gains access to at least one legitimate account node 506, the at least one legitimate account node 506 may be a victim account node 508. In some non-limiting embodiments or aspects, BEC pattern 510 may include graphical representations of malicious account nodes 512 transferring funds from victim account nodes 508 to malicious account nodes 512 via fund transfer directions 516. Graphical representation of fund and/or data transfer is shown by fund transfer directions 516. In some non-limiting embodiments or aspects, BEC pattern 510 may include graphical representations of malicious account nodes 512 transferring funds to other malicious account nodes 512 via fund transfer directions 516. In some non-limiting embodiments or aspects, BEC pattern 510 may include one victim account node 508. In some non-limiting embodiments or aspects, BEC pattern 510 may include graphical representations of one victim account node 508 transferring funds to one malicious account node 512 via fund transfer directions 516. In some non-limiting embodiments or aspects, BEC pattern 510 may include graphical representations of the one malicious account node 512 transferring funds to one or more other malicious account nodes 512 via fund transfer directions 516.

As shown in FIG. 5C, APP pattern 520 may include payment communities 502, money mule communities 504, legitimate account nodes 506, victim account nodes 508, malicious account nodes 512, account connections 514, and fund transfer directions 516. In some non-limiting embodiments or aspects, payment communities 502 may include legitimate account nodes 506, victim account nodes 508, and/or account connections 514. In some non-limiting embodiments or aspects, payment communities 502 may be connected to other payment communities 502 via account connections 514 between legitimate account nodes 506 in each of the connected payment communities 502. In some non-limiting embodiments or aspects, money mule communities 504 may include malicious account nodes 512 and fund transfer directions 516. In some non-limiting embodiments or aspects, fund transfer directions 516 may begin in payment community 502 and end in money mule community 504. In some non-limiting embodiments or aspects, victim account nodes 508 may include legitimate account nodes 506 which have been accessed by at least one malicious account node 512. In some non-limiting embodiments or aspects, legitimate account nodes 506 may be the same as or similar to victim account nodes 508.

In some non-limiting embodiments or aspects, APP pattern 520 may include graphical representations of interactions and/or transactions (e.g., connections) between legitimate account nodes 506 and/or victim account nodes 508 via account connections 514. Graphical representation of connections between legitimate account nodes 506 and/or victim account nodes 508 is shown by account connections 514. In some non-limiting embodiments or aspects, APP pattern 520 may include graphical representations of malicious account nodes 512 gaining access to legitimate account nodes 506 via victim account nodes 508. Where at least one malicious account node 512 gains access to at least one legitimate account node 506, the at least one legitimate account node 506 may be a victim account node 508. In some non-limiting embodiments or aspects, APP pattern 520 may include graphical representations of malicious account nodes 512 transferring funds from victim account nodes 508 to malicious account nodes 512 via fund transfer directions 516. Graphical representation of fund and/or data transfer is shown by fund transfer directions 516. In some non-limiting embodiments or aspects, APP pattern 520 may include graphical representations of malicious account nodes 512 transferring funds to other malicious account nodes 512 via fund transfer directions 516. In some non-limiting embodiments or aspects, APP pattern 520 may include one or more victim account nodes 508. In some non-limiting embodiments or aspects, APP pattern 520 may include graphical representations of one or more victim account nodes 508 transferring funds to one malicious account node 512 via fund transfer directions 516. In some non-limiting embodiments or aspects, APP pattern 520 may include graphical representations of one malicious account node 512 transferring funds to one or more other malicious account nodes 512 via fund transfer directions 516.

As shown in FIG. 5D, pyramid scam pattern 530 may include payment communities 502, money mule communities 504, legitimate account nodes 506, victim account nodes 508, malicious account nodes 512, account connections 514, and fund transfer directions 516. In some non-limiting embodiments or aspects, payment communities 502 may include legitimate account nodes 506, victim account nodes 508, account connections 514, and/or fund transfer directions 516. In some non-limiting embodiments or aspects, payment communities 502 may be connected to other payment communities 502 via account connections 514 between legitimate account nodes 506 and/or victim account nodes 508 in each of the connected payment communities 502. In some non-limiting embodiments or aspects, money mule communities 504 may include malicious account nodes 512 and fund transfer directions 516. In some non-limiting embodiments or aspects, fund transfer directions 516 may begin in payment community 502 and end in money mule community 504. In some non-limiting embodiments or aspects, victim account nodes 508 may include legitimate account nodes 506 which have been accessed by at least one malicious account node 512. In some non-limiting embodiments or aspects, legitimate account nodes 506 may be the same as or similar to victim account nodes 508.

In some non-limiting embodiments or aspects, pyramid scam pattern 530 may include graphical representations of interactions and/or transactions (e.g., connections) between legitimate account nodes 506 and/or victim account nodes 508 via account connections 514. Graphical representation of connections between legitimate account nodes 506 and/or victim account nodes 508 is shown by account connections 514. In some non-limiting embodiments or aspects, pyramid scam pattern 530 may include graphical representations of malicious account nodes 512 gaining access to legitimate account nodes 506 via victim account nodes 508. Where at least one malicious account node 512 gains access to at least one legitimate account node 506, the at least one legitimate account node 506 may be a victim account node 508. In some non-limiting embodiments or aspects, pyramid scam pattern 530 may include one or more victim account nodes 508. In some non-limiting embodiments or aspects, pyramid scam pattern 530 may include graphical representations of malicious account nodes 512 transferring funds from victim account nodes 508 to malicious account nodes 512 via fund transfer directions 516. Graphical representation of fund and/or data transfer is shown by fund transfer directions 516. In some non-limiting embodiments or aspects, pyramid scam pattern 530 may include graphical representations of victim account nodes 508 transferring funds from one or more other victim account nodes 508 to other victim account nodes 508 via fund transfer directions 516. In some non-limiting embodiments or aspects, pyramid scam pattern 530 may include graphical representations of malicious account nodes 512 transferring funds to other malicious account nodes 512 via fund transfer directions 516. In some non-limiting embodiments or aspects, pyramid scam pattern 530 may include graphical representations of one or more victim account nodes 508 transferring funds to one malicious account node 512 via fund transfer directions 516. In some non-limiting embodiments or aspects, pyramid scam pattern 530 may include graphical representations of one malicious account node 512 transferring funds to one or more other malicious account nodes 512 via fund transfer directions 516.

Referring now to FIG. 5E, FIG. 5E is a diagram of a non-limiting embodiment or aspect of an implementation of step 540 of a process (e.g., process 300) for inserting a pattern representing fraud adversarial activity. As shown in FIG. 5E, implementation of step 540 may include graph generation system 102 performing step 540 of the process.

As shown by reference number 505 in FIG. 5E, graph generation system 102 may insert patterns representing adversarial activity. In some non-limiting embodiments or aspects, graph generation system 102 may insert patterns representing adversarial activity based on generating a plurality of dynamic payment graphs. In some non-limiting embodiments or aspects, graph generation system 102 may insert a difference in patterns (e.g., including transaction volume and/or transaction amount) at different times of day and/or days of a week).

In some non-limiting embodiments or aspects, graphical representations of patterns representing adversarial activity may include ATO pattern 500, BEC pattern 510, APP pattern 520, and pyramid scam pattern 530. In some non-limiting embodiments or aspects, graph generation system 102 may insert patterns representing fraud adversarial activity into the plurality of dynamic payment graphs. For example, graph generation system 102 may insert one or more of ATO pattern 500, BEC pattern 510, APP pattern 520, and/or pyramid scam pattern 530 into a plurality of dynamic payment graphs to generate synthetic payment graphs. In some non-limiting embodiments or aspects, graph generation system 102 may input the synthetic payment graphs to one or more machine learning models to train the one or more machine learning models. In some non-limiting embodiments or aspects, graph generation system 102 may insert patterns representing adversarial activity based on creating representations of real-time payment transactions. In some non-limiting embodiments or aspects, graph generation system 102 may insert patterns representing adversarial activity to train one or more machine learning models, such that graph generation system 102 may perform an action associated with a machine learning technique.

In some non-limiting embodiments or aspects, graph generation system 102 may insert ATO pattern 500 into a plurality of dynamic payment graphs. In some non-limiting embodiments or aspects, graph generation system 102 may insert ATO pattern 500 into a plurality of dynamic payment graphs by generating a graph of ATO pattern 500, sampling a dynamic payment graph for legitimate account node 506, sampling the graph of ATO pattern 500 for a plurality of malicious account nodes 512, and connecting legitimate account node 506 and at least one malicious account node 512. In some non-limiting embodiments or aspects, graph generation system 102 may sample a dynamic payment graph for legitimate account node 506 by randomly sampling a dynamic payment graph for a node and selecting the node to represent victim account node 508. In some non-limiting embodiments, graph generation system 102 may sample a plurality of malicious account nodes 512. In some non-limiting embodiments or aspects, malicious account nodes 512 may be sampled from a specific community. In some non-limiting embodiments or aspects, malicious account nodes 512 may be sampled from a community of diverse backgrounds. In one example, an account which has good (e.g., non-malicious) records for a time period may be stolen and become a malicious account.

In some non-limiting embodiments or aspects, graph generation system 102 may sample a plurality of malicious accounts nodes 512 by sampling one or more malicious account nodes 512 from a malicious account node 512 pool in the graph of ATO pattern 500 to represent first-level malicious account nodes 512. In some non-limiting embodiments or aspects, a first-level malicious account node 512 may directly connect to the victim account nodes 508). In some non-limiting embodiments or aspects, graph generation system 102 may connect the sampled victim account node 508 and the one or more malicious account nodes 512. In some non-limiting embodiments or aspects, graph generation system 102 may cause victim account node 508 to repeatedly transfer funds to the one or more malicious account nodes 512 by sampling the dynamic payment graph with ATO pattern 500 inserted and assigning dynamic attributes to the dynamic payment graph. In some non-limiting embodiments or aspects, the one or more malicious account nodes 512 may connect to one or more money laundering patterns and/or other malicious account nodes 512 in the dynamic payment graph.

In some non-limiting embodiments or aspects, graph generation system 102 may insert BEC pattern 510 into a plurality of dynamic payment graphs by generating BEC pattern 510, sampling a dynamic payment graph for a business account, sampling a plurality of malicious account nodes 512, and connecting the business account and malicious account node 512. In some non-limiting embodiments or aspects, graph generation system 102 may sample a dynamic payment graph for a business account by randomly sampling a dynamic payment graph for a node that has an attribute assigned to the node representing a business account and selecting the node to represent the business account. In some non-limiting embodiments or aspects, graph generation system 102 may sample a graph of BEC pattern 510 for a plurality of malicious account nodes 512 by sampling malicious account nodes 512 from a malicious account node 512 pool to represent malicious account node 512. In some non-limiting embodiments or aspects, graph generation system 102 may connect the selected business account and malicious account node 512. In some non-limiting embodiments or aspects, graph generation system 102 may cause the business account to transfer funds to malicious account node 512 by sampling the dynamic payment graph with BEC pattern 510 inserted and assigning dynamic attributes to the dynamic payment graph. In some non-limiting embodiments or aspects, the transaction amount of the fund transfer from the sampled business account to malicious account node 512 may be limited based on an upper limit and a lower limit transaction amount derived from transaction metadata. In some non-limiting embodiments or aspects, malicious account node 512 may connect to one or more money laundering patterns and/or other malicious account nodes 512.

In some non-limiting embodiments or aspects, graph generation system 102 may insert APP pattern 520 into a plurality of dynamic payment graphs by generating a graph of APP pattern 520, sampling a dynamic payment graph for a plurality of legitimate account nodes 506, sampling the graph of APP pattern 520 for a plurality of malicious account nodes 512, and connecting the plurality of legitimate account nodes 506 and malicious account node 512. In some non-limiting embodiments or aspects, graph generation system 102 may sample a dynamic payment graph for a plurality of legitimate account nodes 506 by randomly sampling a dynamic payment graph for a plurality of nodes and selecting a plurality of nodes to represent a plurality of victim account nodes 508. In some non-limiting embodiments or aspects, graph generation system 102 may sample a plurality of malicious account nodes 512 by sampling the graph of APP pattern 520 for a plurality of malicious account nodes 512 from a malicious account node 512 pool and selecting malicious account node 512 to represent malicious account node 512. In some non-limiting embodiments or aspects, graph generation system 102 may connect the selected plurality of victim account nodes 508 and malicious account node 512. In some non-limiting embodiments or aspects, graph generation system 102 may cause each victim account node 508 of the plurality of victim account nodes 508 to transfer funds to malicious account node 512 by sampling the dynamic payment graph with APP pattern 520 inserted and assigning dynamic attributes to the dynamic payment graph. In some non-limiting embodiments or aspects, a transaction amount of the fund transfer from the sampled plurality of victim account nodes 508 to malicious account node 512 may be based on the number of victim account nodes 508 in the plurality of victim account nodes 508. For example, if the number of victim account nodes 508 in the plurality of victim account nodes 508 is higher, the transaction amount from each victim account node 508 to malicious account node 512 may be lower, and if the number of victim account nodes 508 of the plurality of victim account nodes 508 is lower, the transaction amount from each victim account node 508 to malicious account node 512 may be higher. In some non-limiting embodiments or aspects, malicious account node 512 may connect to one or more money laundering patterns and/or other malicious account nodes 512.

In some non-limiting embodiments or aspects, graph generation system 102 may insert pyramid scam pattern 530 into a plurality of dynamic payment graphs by generating a graph of pyramid scam pattern 530, sampling a dynamic payment graph for a plurality of legitimate account nodes 506, sampling a plurality of malicious account nodes 512, and connecting the plurality of legitimate account nodes 506 and malicious account node 512. In some non-limiting embodiments or aspects, graph generation system 102 may sample a dynamic payment graph for a plurality of legitimate account nodes 506 by randomly sampling a dynamic payment graph for a plurality of nodes and selecting the plurality of nodes of legitimate account nodes 506 to represent a plurality of victim account nodes 508. In some non-limiting embodiments or aspects, graph generation system 102 may sample a plurality of malicious account nodes 512 by sampling malicious account nodes 512 from a malicious account node 512 pool and selecting malicious account node 512 to represent malicious account node 512. In some non-limiting embodiments or aspects, graph generation system 102 may connect the plurality of victim account nodes 508 and malicious account node 512. In some non-limiting embodiments or aspects, graph generation system 102 may cause each victim account node 508 of the plurality of victim account nodes 508 to transfer funds to malicious account node 512 by sampling the dynamic payment graph with pyramid scam pattern 530 inserted and assigning dynamic attributes to the dynamic payment graph. In some non-limiting embodiments or aspects, graph generation system 102 may cause a portion of the plurality of the victim account nodes 508 to transfer funds to one or more other victim account nodes 508 of the plurality of victim account nodes 508. In some non-limiting embodiments or aspects, two or more victim account nodes 508 of the plurality of victim account nodes 508 may be from the same payment community 502. In some non-limiting embodiments or aspects, malicious account node 512 may connect to one or more money laundering patterns and/or other malicious account nodes 512.

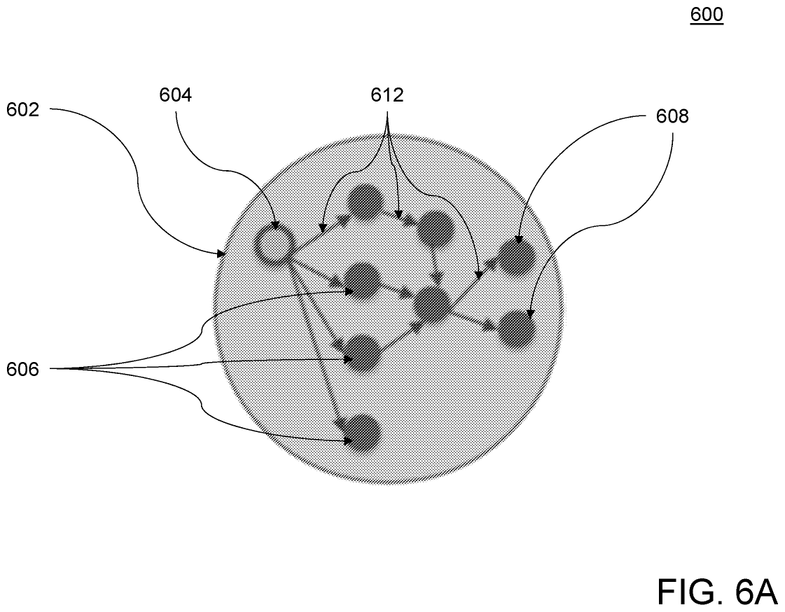

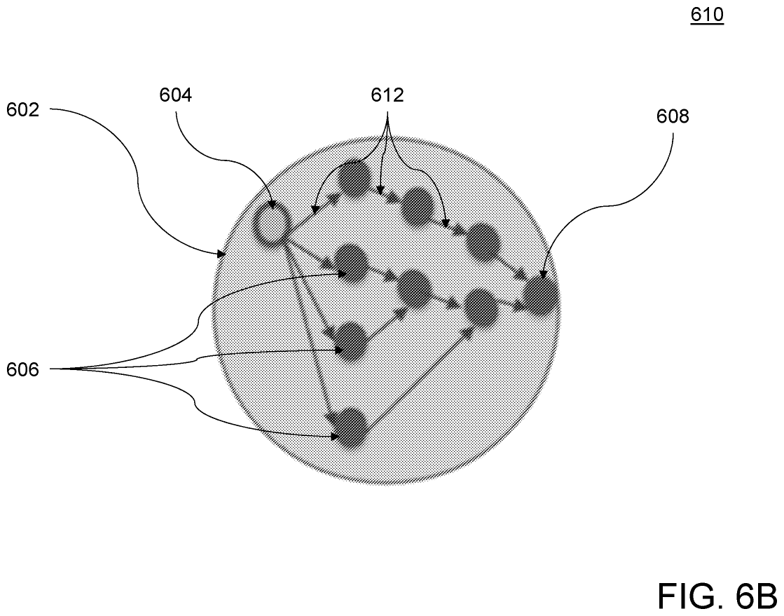

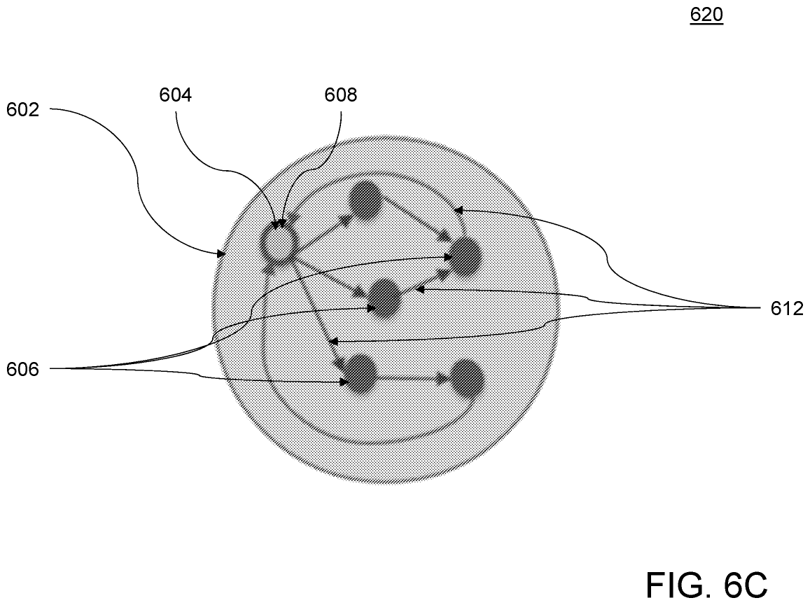

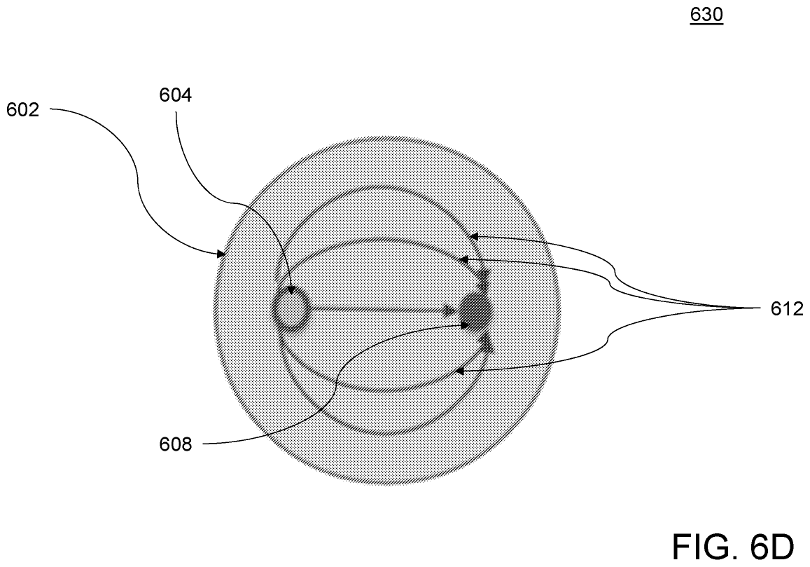

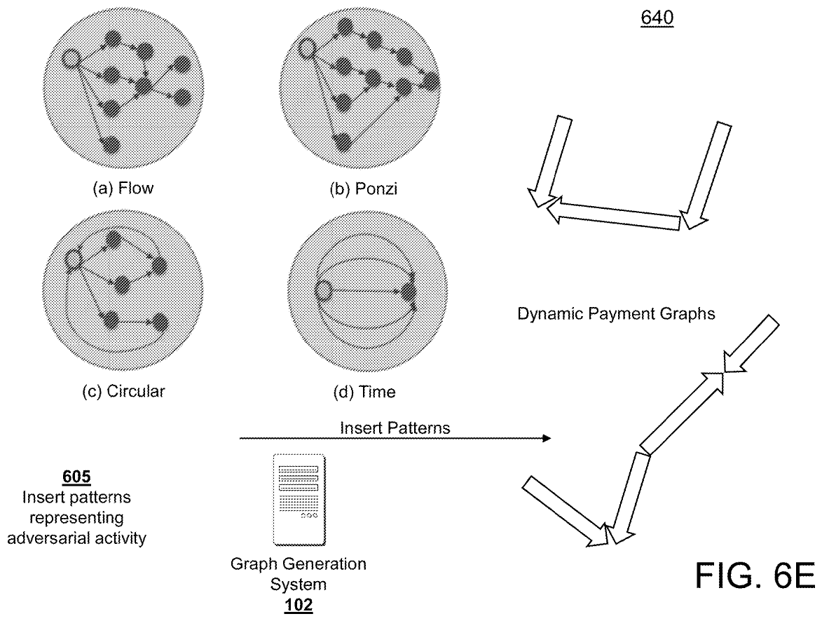

Referring now to FIGS. 6A-6D, FIGS. 6A-6D are diagrams of non-limiting embodiments or aspects of graphical representations of patterns representing money laundering adversarial activity. As shown in FIGS. 6A-6D, graphical representations of patterns representing money laundering adversarial activity may include flow pattern 600, Ponzi pattern 610, circular pattern 620, and time pattern 630.

As shown in FIG. 6A, flow pattern 600 may include money mule communities 602, victim account nodes 604 (e.g., a plurality of victim accounts, a victim account, etc.), malicious account nodes 606 (e.g., a plurality of malicious accounts, a malicious account, etc.), target account nodes 608 (e.g., a plurality of target accounts, target account nodes, etc.), and fund transfer directions 612. In some non-limiting embodiments or aspects, money mule communities 602 may contain victim account nodes 604, malicious account nodes 606, target account nodes 608, and/or fund transfer directions 612. In some non-limiting embodiments or aspects, flow pattern 600 may have a plurality of layers where each layer may include one or more malicious account nodes 606. In some non-limiting embodiments or aspects, flow pattern 600 may have as few as three layers or as many as ten layers.

In some non-limiting embodiments or aspects, flow pattern 600 may include graphical representations of malicious account nodes 606 possessing access to victim account nodes 604. In some non-limiting embodiments or aspects, flow pattern 600 may include graphical representations of malicious account nodes 606 transferring funds from victim account nodes 604 to malicious account nodes 606 via fund transfer directions 612. Graphical representation of fund and/or data transfer is shown by fund transfer directions 612. In some non-limiting embodiments or aspects, flow pattern 600 may include graphical representations of malicious account nodes 606 transferring funds to other malicious account nodes 606 via fund transfer directions 612. In some non-limiting embodiments or aspects, flow pattern 600 may include graphical representations of victim account node 604 transferring funds to one or more selected malicious account node 606 via fund transfer directions 612. In some non-limiting embodiments or aspects, flow pattern 600 may include graphical representations of the one or more malicious account nodes 606 transferring funds to one or more other malicious account nodes 606 via fund transfer directions 612. In some non-limiting embodiments or aspects, a target account node may include a representation of an account that may receive funds from a malicious account. In some non-limiting embodiments or aspects, flow pattern 600 may include graphical representations of one or more malicious account nodes 606 transferring funds to one or more target account nodes 608.

As shown in FIG. 6B, Ponzi pattern 610 may include money mule communities 602, victim account nodes 604, malicious account nodes 606, target account nodes 608, and fund transfer directions 612. In some non-limiting embodiments or aspects, money mule communities 602 may include victim account nodes 604, malicious account nodes 606, target account nodes 608, and/or fund transfer directions 612. In some non-limiting embodiments or aspects, Ponzi pattern 610 may include only one target account node 608.

In some non-limiting embodiments or aspects, Ponzi pattern 610 may include graphical representations of malicious account nodes 606 possessing access to victim account nodes 604. In some non-limiting embodiments or aspects, Ponzi pattern 610 may include graphical representations of malicious account nodes 606 transferring funds from victim account nodes 604 to malicious account nodes 606 via fund transfer directions 612. Graphical representation of fund and/or data transfer is shown by fund transfer directions 612. In some non-limiting embodiments or aspects, Ponzi pattern 610 may include graphical representations of one or more malicious account nodes 606 transferring funds to at least one other malicious account node 606 via fund transfer directions 612. In some non-limiting embodiments or aspects, Ponzi pattern 610 may include graphical representations of victim account node 604 transferring funds to one or more malicious account nodes 606 via fund transfer directions 612. In some non-limiting embodiments or aspects, Ponzi pattern 600 may include graphical representations of one or more malicious account nodes 606 transferring funds to one target account node 608 via fund transfer directions 612. In some non-limiting embodiments or aspects, Ponzi pattern 610 may include graphical representations of malicious account nodes 606 receiving funds from one or more other malicious account nodes 606.

As shown in FIG. 6C, circular pattern 620 may include money mule communities 602, victim account nodes 604, malicious account nodes 606, target account nodes 608, and fund transfer directions 612. In some non-limiting embodiments or aspects, money mule communities 602 may include victim account nodes 604, malicious account nodes 606, target account nodes 608, and/or fund transfer directions 612. In some non-limiting embodiments or aspects, victim account nodes 604 may be the same as or similar to target account nodes 608.

In some non-limiting embodiments or aspects, a source account node may include a representation of an account having a source of funds that may be transferred to a malicious account node. In some non-limiting embodiments or aspects, a source account may include a representation of an account that may receive funds from malicious accounts. In some non-limiting embodiments or aspects, a source account node may include a representation of an account which may be the same as or similar to a victim account and a target account. In some non-limiting embodiments or aspects, a malicious account node may include a representation of an account that receives and/or transmits funds that have been transferred from the source of funds (e.g., a source account node).

In some non-limiting embodiments or aspects, circular pattern 620 may include graphical representations of malicious account nodes 606 possessing access to victim account nodes 604. In some non-limiting embodiments or aspects, circular pattern 620 may include graphical representations of malicious account nodes 606 transferring funds from victim account nodes 604 to malicious account nodes 606 via fund transfer directions 612. Graphical representation of fund and/or data transfer is shown by fund transfer directions 612. In some non-limiting embodiments or aspects, circular pattern 620 may include graphical representations of malicious account nodes 606 transferring funds to one or more other malicious account nodes 606 via fund transfer directions 612. In some non-limiting embodiments or aspects, circular pattern 620 may include graphical representations of malicious account nodes 606 transferring funds to one other malicious account node 606 via fund transfer directions 612. In some non-limiting embodiments or aspects, circular pattern 620 may include graphical representations of victim account node 604 transferring funds to one or more malicious account nodes 606 via fund transfer directions 612. In some non-limiting embodiments or aspects, circular pattern 620 may include graphical representations of one or more malicious account nodes 606 transferring funds to at least one victim account node 604 via fund transfer directions 612. In some non-limiting embodiments or aspects, circular pattern 620 may include graphical representations of malicious account nodes 606 receiving funds from one or more other malicious account nodes 606.

In some non-limiting embodiments or aspects, circular pattern 620 may include a source account node. In some non-limiting embodiments or aspects, the source account node may be victim account node 604 and target account node 608.

As shown in FIG. 6D, time pattern 630 may include money mule communities 602, victim account nodes 604, target account nodes 608, and fund transfer directions 612. In some non-limiting embodiments or aspects, money mule communities 602 may include victim account nodes 604, target account nodes 608, and/or fund transfer directions 612. In some non-limiting embodiments or aspects, time pattern 630 may include exactly one victim account node 604 and exactly one target account node 608.

In some non-limiting embodiments or aspects, time pattern 630 may include graphical representations of victim account node 604 transferring funds to target account node 608 via fund transfer directions 612. Graphical representation of fund and/or data transfer is shown by fund transfer directions 612. In some non-limiting embodiments or aspects, time pattern 630 may include graphical representations of victim account node 604 making a plurality of fund transfers to target account node 608. In some non-limiting embodiments or aspects, time pattern 630 may include a plurality of fund transfers where each fund transfer occurs at a discrete time within a time sequence.

Referring now to FIG. 6E, FIG. 6E is a diagram of a non-limiting embodiment or aspect of an implementation 640 of step of a process (e.g., process 300) for inserting a pattern representing money laundering adversarial activity. As shown in FIG. 6E, implementation of step 640 may include graph generation system 102 performing step 640 of the process.

As shown by reference number 605 in FIG. 6E, graph generation system 102 may insert patterns representing adversarial activity. In some non-limiting embodiments or aspects, graph generation system 102 may insert patterns representing adversarial activity based on generating a plurality of dynamic payment graphs. In some non-limiting embodiments or aspects, graphical representations of patterns representing adversarial activity may include flow pattern 600, Ponzi pattern 610, circular pattern 620, and time pattern 630. In some non-limiting embodiments or aspects, graph generation system 102 may insert patterns representing money laundering adversarial activity into a plurality of dynamic payment graphs. For example, graph generation system 102 may insert one or more of flow pattern 600, Ponzi pattern 610, circular pattern 620, and/or time pattern 630 into a plurality of dynamic payment graphs to generate synthetic payment graphs. In some non-limiting embodiments or aspects, graph generation system 102 may input the synthetic payment graphs to one or more machine learning models to train the one or more machine learning models. In some non-limiting embodiments or aspects, graph generation system 102 may insert patterns representing adversarial activity based on creating representations of real-time payment transactions. In some non-limiting embodiments or aspects, graph generation system 102 may insert patterns representing adversarial activity to train one or more machine learning models, such that graph generation system 102 may perform an action associated with a machine learning technique.

In some non-limiting embodiments or aspects, graph generation system 102 may insert flow pattern 600 into a plurality of dynamic payment graphs by generating a graph of flow pattern 600. In some non-limiting embodiments or aspects, graph generation system 102 may generate the graph of flow pattern 600 based on victim account node 604, a number of layers, a range of nodes in a layer, and a dictionary including a plurality of new accounts. In some non-limiting embodiments or aspects, victim account node 604, the number of layers, the range of nodes in a layer, and the dictionary including a plurality of new accounts may be provided as input from a user to graph generation system 102. In some non-limiting embodiments or aspects, graph generation system 102 may generate flow pattern 600 by iterating over the number of layers. In some non-limiting embodiments or aspects, graph generation system 102 may create a list of nodes for each layer of the number of layers. In some non-limiting embodiments or aspects, graph generation system 102 may randomly select a destination node from a next (e.g., n+1) layer. In some non-limiting embodiments or aspects, a destination node may include malicious account node 606. In some non-limiting embodiments or aspects, a destination node may include target account node 608. In some non-limiting embodiments or aspects, graph generation system 102 may create a transaction from victim account node 604 to a destination node. In some non-limiting embodiments or aspects, graph generation system 102 may iterate over each node of the range of nodes in each layer of the plurality of layers when selecting a destination node for each victim account node 604, malicious account node 606, and/or destination node.

In some non-limiting embodiments or aspects, graph generation system 102 may create a transaction from victim account node 604 to a destination node by sampling a dynamic payment graph. In some non-limiting embodiments or aspects, graph generation system 102 may create a transaction from a destination node to another destination node by sampling a dynamic payment graph. In some non-limiting embodiments or aspects, graph generation system 102 may create a transaction from a destination node to target account node 608 by sampling a dynamic payment graph. In some non-limiting embodiments or aspects, graph generation system 102 may create more than one transaction from victim account node 604 or a destination node to one or more other destination nodes or one or more target account nodes 608. In some non-limiting embodiments or aspects, graph generation system 102 may divide a transaction amount assigned to the victim account node 604 or the destination node between the transactions to the one or more destination nodes or the one or more target account nodes 608. In some non-limiting embodiments or aspects, graph generation system 102 may iterate over each node of the range of nodes in each layer of the plurality of layers.

In some non-limiting embodiments or aspects, graph generation system 102 may insert Ponzi pattern 610 into a plurality of dynamic payment graphs by generating a graph of Ponzi pattern 610. In some non-limiting embodiments or aspects, graph generation system 102 may generate a graph of Ponzi pattern 610 based on victim account node 604, a parameter of layers, a range of nodes in a layer, and a dictionary including a plurality of new accounts. In some non-limiting embodiments or aspects, victim account node 604, the parameter of layers, the range of nodes in a layer, and the dictionary including a plurality of new accounts may be provided as input from a user to graph generation system 102. In some non-limiting embodiments or aspects, graph generation system 102 may generate Ponzi pattern 610 by iterating over a parameter of layers. In some non-limiting embodiments or aspects, graph generation system 102 may create a list of nodes for each layer. In some non-limiting embodiments or aspects, graph generation system 102 may randomly select a destination node from a next (e.g., n+1) layer. In some non-limiting embodiments or aspects, a destination node may include malicious account node 606. In some non-limiting embodiments or aspects, a destination node may include target account node 608. In some non-limiting embodiments or aspects, graph generation system 102 may create a transaction from victim account node 604 to a destination node. In some non-limiting embodiments or aspects, graph generation system 102 may iterate over each node of the range of nodes in each layer of the plurality of layers when selecting a destination node for each victim account node 604, malicious account node 606, and/or destination node. In some non-limiting embodiments or aspects, graph generation system 102 may create a transaction from victim account node 604 to a destination node by sampling a dynamic payment graph. In some non-limiting embodiments or aspects, graph generation system 102 may generate a graph of Ponzi pattern 610 in a similar manner to generating a graph of flow pattern 600.

In some non-limiting embodiments or aspects, graph generation system 102 may insert circular pattern 620 into a plurality of dynamic payment graphs by generating circular pattern 620. In some non-limiting embodiments or aspects, graph generation system 102 may generate circular pattern 620 based on target account node 608, a parameter of layers, a range of nodes in a layer, and a dictionary including a plurality of new accounts. In some non-limiting embodiments or aspects, target account node 608, the parameter of layers, the range of nodes in a layer, and the dictionary including a plurality of new accounts may be provided as input from a user to graph generation system 102. In some non-limiting embodiments or aspects, graph generation system 102 may generate circular pattern 620 by iterating over a parameter of layers. In some non-limiting embodiments or aspects, graph generation system 102 may create a list of nodes for each layer. In some non-limiting embodiments or aspects, graph generation system 102 may randomly select a destination node from a n+1 layer. In some non-limiting embodiments or aspects, a destination node may include malicious account node 606. In some non-limiting embodiments or aspects, a destination node may include target account node 608. In some non-limiting embodiments or aspects, graph generation system 102 may create a transaction from victim account node 604 to a destination node. In some non-limiting embodiments or aspects, graph generation system 102 may iterate over each node of the range of nodes in each layer of the plurality of layers when selecting a destination node for each victim account node 604, malicious account node 606, and/or destination node. In some non-limiting embodiments or aspects, graph generation system 102 may create a transaction from victim account node 604 to a destination node by sampling a dynamic payment graph. In some non-limiting embodiments or aspects, graph generation system 102 may generate a graph of circular pattern 620 in a similar manner to generating a graph of flow pattern 600.

In some non-limiting embodiments or aspects, graph generation system 102 may insert time pattern 630 into a plurality of dynamic payment graphs by generating time pattern 630. In some non-limiting embodiments or aspects, graph generation system 102 may generate time pattern 630 based on target account node 608, a time duration, and a plurality of discrete times within the time duration. In some non-limiting embodiments or aspects, target account node 608, the time duration, and the plurality of discrete times within the time duration may be provided as input from a user to graph generation system 102. In some non-limiting embodiments or aspects, graph generation system 102 may generate time pattern 630 by iterating over the time duration at a specified time step. In some non-limiting embodiments or aspects, graph generation system 102 may initiate each of the plurality of transactions from victim account node 604 to target account node 608 at a discrete time within a time duration. In some non-limiting embodiments or aspects, graph generation system 102 may iterate over each node of the range of nodes in each layer of the plurality of layers when selecting a destination node for each victim account node 604, malicious account node 606, and/or destination node. In some non-limiting embodiments or aspects, graph generation system 102 may create a plurality of transactions from victim account node 604 to target account node 608 by sampling a dynamic payment graph. In some non-limiting embodiments or aspects, graph generation system 102 may generate a graph of time pattern 640 in a similar manner to generating a graph of flow pattern 600.

Although the present disclosure has been described in detail for the purpose of illustration based on what is currently considered to be the most practical and preferred embodiments or aspects, it is to be understood that such detail is solely for that purpose and that the present disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A method, comprising:
generating, with at least one processor, a base payment graph comprising a plurality of nodes and a plurality of edges connecting the plurality of nodes, wherein each node represents an entity and each edge represents a probability that a real-time payment transaction may be conducted involving two entities that are connected by the edge, wherein the real-time payment transaction is artificially created, such that transaction data associated with the real-time payment transaction is based on a payment transaction that took place in a real-world setting and the transaction data with the real-time payment transaction is not the same as transaction data associated with the payment transaction that took place in the real-world setting, and wherein generating the base payment graph comprises:
assigning a plurality of account parameters to each of the plurality of nodes of the base payment graph; and
assigning at least one interaction parameter to each edge of the plurality of edges of the base payment graph;
generating, with the at least one processor, a plurality of dynamic payment graphs based on the base payment graph, wherein each dynamic payment graph of the plurality of dynamic payment graphs comprises a plurality of edges, wherein each edge of the plurality of edges comprises real-time-payment transaction parameters, and wherein generating the plurality of dynamic payment graphs comprises:
sampling a first plurality of nodes and a first plurality of edges of the base payment graph to generate the plurality of dynamic payment graphs, wherein each dynamic payment graph is associated with a different discrete time period;
inserting, with the at least one processor, patterns representing adversarial activity into the plurality of dynamic payment graphs to provide a synthetic graph, wherein the patterns comprise a pattern representing fraud adversarial activity, a pattern representing money laundering adversarial activity, or any combination thereof;
generating, with the at least one processor, a training dataset based on inserting the patterns representing adversarial activity into the plurality of dynamic payment graphs, wherein the training dataset comprises a plurality of transactions from the synthetic graph that represent payment transactions involving adversarial activity, and wherein the plurality of transactions is based on at least one dynamic payment graph of the plurality of dynamic payment graphs;
training, with the at least one processor, a machine learning model based on the training dataset to provide a trained machine learning model; and
performing, with the at least one processor, an action associated with detecting criminal behavior using the trained machine learning model.

2. The method of claim 1, wherein performing the action associated with detecting criminal behavior using the trained machine learning model comprises:
determining, with the trained machine learning model, that a pattern representing fraud adversarial activity, a pattern representing money laundering adversarial activity, or any combination thereof is present in another base payment graph; and
detecting a transaction, an account, an accountholder, or any combination thereof as being associated with criminal behavior based on determining that the pattern representing fraud adversarial activity, a pattern representing money laundering adversarial activity, or any combination thereof is present in the another base payment graph.

3. The method of claim 1, further comprising:
assigning a probability parameter to each edge of the plurality of edges.

4. The method of claim 1, wherein generating the base payment graph comprises:
generating the base payment graph based on a plurality of Barabasi-Albert graph structures.

5. The method of claim 1, wherein a number of nodes of the plurality of nodes in the base payment graph is a user selectable parameter and wherein the number of edges of the plurality of edges is based on the number of nodes of the plurality of nodes.

6. The method of claim 1, wherein generating the plurality of dynamic payment graphs comprises:
assigning dynamic graph attributes to each edge of the plurality of edges of the plurality of dynamic payment graphs based on static graph attributes assigned to each node and each edge of the base payment graph.

7. The method of claim 6, wherein generating the plurality of dynamic payment graphs comprises:
assigning dynamic graph attributes to each edge of the plurality of edges of the plurality of dynamic payment graphs based on a predefined statistical distribution.

8. A system, comprising:
at least one processor programmed or configured to:
generate a base payment graph comprising a plurality of nodes and a plurality of edges connecting the plurality of nodes, wherein each node represents an entity and each edge represents a probability that a real-time payment transaction may be conducted involving two entities that are connected by the edge, wherein the real-time payment transaction is artificially created, such that transaction data associated with the real-time payment transaction is based on a payment transaction that took place in a real-world setting and the transaction data with the real-time payment transaction is not the same as transaction data associated with the payment transaction that took place in the real-world setting, and wherein, when generating the base payment graph, the at least one processor is programmed or configured to:
assign a plurality of account parameters to each of the plurality of nodes of the base payment graph; and
assign at least one interaction parameter to each edge of the plurality of edges of the base payment graph;
generate a plurality of dynamic payment graphs based on the base payment graph, wherein each dynamic payment graph of the plurality of dynamic payment graphs comprises a plurality of edges, wherein each edge of the plurality of edges comprises real-time-payment transaction parameters, and wherein, when generating the plurality of dynamic payment graphs, the at least one processor is programmed or configured to:
sample a first plurality of nodes and a first plurality of edges of the base payment graph to generate the plurality of dynamic payment graphs, wherein each dynamic payment graph is associated with a different discrete time period;
insert patterns representing adversarial activity into the plurality of dynamic payment graphs to provide a synthetic graph, wherein the patterns comprise a pattern representing fraud adversarial activity, a pattern representing money laundering adversarial activity, or any combination thereof;
generate a training dataset based on inserting the patterns representing adversarial activity into the plurality of dynamic payment graphs, wherein the training dataset comprises a plurality of transactions of the synthetic graph that represent payment transactions involving adversarial activity, and wherein the plurality of transactions is based on at least one dynamic payment graph of the plurality of dynamic payment graphs;
train a machine learning model based on the training dataset to provide a trained machine learning model; and
perform an action associated with detecting criminal behavior using the trained machine learning model.

9. The system of claim 8, wherein, when performing the action associated with detecting criminal behavior the at least one processor is programmed or configured to:
determine that a pattern representing fraud adversarial activity, a pattern representing money laundering adversarial activity, or any combination thereof is present in another base payment graph; and
detect a transaction, an account, an accountholder, or any combination thereof as being associated with criminal behavior based on determining that the pattern representing fraud adversarial activity, a pattern representing money laundering adversarial activity, or any combination thereof is present in the another base payment graph.

10. The system of claim 8, wherein the at least one processor is further programmed or configured to:
assign a probability parameter to each edge of the plurality of edges.

11. The system of claim 8, wherein, when generating the base payment graph, the at least one processor is programmed or configured to:
generate the base payment graph based on a plurality of Barabasi-Albert graph structures.

12. The system of claim 8, wherein a number of nodes of the plurality of nodes in the base payment graph is a user selectable parameter and wherein the number of edges of the plurality of edges is based on the number of nodes of the plurality of nodes.

13. The system of claim 8, wherein, when generating the plurality of dynamic payment graphs, the at least one processor is programmed or configured to:
assign dynamic graph attributes to each edge of the plurality of edges of the plurality of dynamic payment graphs based on static graph attributes assigned to each node and each edge of the base payment graph.

14. The system of claim 8, wherein, when generating the plurality of dynamic payment graphs, the at least one processor is programmed or configured to:
assign dynamic graph attributes to each edge of the plurality of edges of the plurality of dynamic payment graphs based on a predefined statistical distribution.

15. A computer program product, the computer program product comprising at least one non-transitory computer-readable medium including one or more instructions that, when executed by at least one processor, cause the at least one processor to:
generate a base payment graph comprising a plurality of nodes and a plurality of edges connecting the plurality of nodes, wherein each node represents an entity and each edge represents a probability that a real-time payment transaction may be conducted involving two entities that are connected by the edge, wherein the real-time payment transaction is artificially created, such that transaction data associated with the real-time payment transaction is based on a payment transaction that took place in a real-world setting and the transaction data with the real-time payment transaction is not the same as transaction data associated with the payment transaction that took place in the real-world setting, and wherein, the one or more instructions that cause the at least one processor to generate the base payment graph, cause the at least one processor is to:
assign a plurality of account parameters to each of the plurality of nodes of the base payment graph; and
assign at least one interaction parameter to each edge of the plurality of edges of the base payment graph;
generate a plurality of dynamic payment graphs based on the base payment graph, wherein each dynamic payment graph of the plurality of dynamic payment graphs comprises a plurality of edges, wherein each edge of the plurality of edges comprises real-time-payment transaction parameters, and wherein, the one or more instructions that cause the at least one processor to generate the plurality of dynamic payment graphs, cause the at least one processor to:
sample a first plurality of nodes and a first plurality of edges of the base payment graph to generate the plurality of dynamic payment graphs, wherein each dynamic payment graph is associated with a different discrete time period;
insert patterns representing adversarial activity into the plurality of dynamic payment graphs to provide a synthetic graph, wherein the patterns comprise a pattern representing fraud adversarial activity, a pattern representing money laundering adversarial activity, or any combination thereof;
generate a training dataset based on inserting the patterns representing adversarial activity into the plurality of dynamic payment graphs, wherein the training dataset comprises a plurality of transactions of the synthetic graph that represent payment transactions involving adversarial activity, and wherein the plurality of transactions is based on at least one dynamic payment graph of the plurality of dynamic payment graphs;
train a machine learning model based on the training dataset to provide a trained machine learning model; and
perform an action associated with detecting criminal behavior using the trained machine learning model.

16. The computer program product of claim 15, wherein, the one or more instructions that cause the at least one processor to perform the action associated with the trained machine learning model, cause the at least one processor to:
determine that a pattern representing fraud adversarial activity, a pattern representing money laundering adversarial activity, or any combination thereof is present in another base payment graph; and
detect a transaction, an account, an accountholder, or any combination thereof as being associated with criminal behavior based on determining that the pattern representing fraud adversarial activity, a pattern representing money laundering adversarial activity, or any combination thereof is present in the another base payment graph.

17. The computer program product of claim 15, wherein the one or more instructions further cause the at least one processor to:
assign a probability parameter to each edge of the plurality of edges.

18. The computer program product of claim 15, wherein the one or more instructions that cause the at least one processor to generate the base payment graph cause the at least one processor to:
generate the base payment graph based on a plurality of Barabasi-Albert graph structures.

19. The computer program product of claim 15, wherein a number of nodes of the plurality of nodes in the base payment graph is a user selectable parameter and wherein the number of edges of the plurality of edges is based on the number of nodes of the plurality of nodes.

20. The computer program product of claim 15, wherein, when generating the plurality of dynamic payment graphs, the at least one processor is programmed or configured to:
assign dynamic graph attributes to each edge of the plurality of edges of the plurality of dynamic payment graphs based on static graph attributes assigned to each node and each edge of the base payment graph; and
assign dynamic graph attributes to each edge of the plurality of edges of the plurality of dynamic payment graphs based on a predefined statistical distribution.
